(19) United States
(12) Patent Application Publication
(10) Pub. No.: US 2010/0202783 A1
(43) Pub. Date: Aug. 12, 2010

(54) PHASE NOISE SUPPRESSION IN AN OPTICAL SYSTEM

(75) Inventors: Tuomo von Lerber, Helsinki (FI); Marco Mattila, Espoo (FI); Ari Tervonen, Vantaa (FI); Werner Weiershausen, Eppertshausen (DE)

Correspondence Address: BARNES & THORNBURG LLP, 750-17TH STREET NW, SUITE 900, WASHINGTON, DC, 20006-4675, US

(73) Assignee: Luxdyne Ltd., Espoo (FI)

(21) Appl. No.: 12/690,336

(22) Filed: Jan. 20, 2010

Related U.S. Application Data
(60) Provisional application No. 61/150,396, filed on Feb. 6, 2009.

(30) Foreign Application Priority Data
Feb. 6, 2009 (FI) 20095116

(51) Int. Cl. H04B 10/00

(52) U.S. Cl. 398/175

(57) ABSTRACT

An optical signal regeneration technique includes receiving optical symbols in a phase-modulation format. The received symbols are converted to symbols in a phase/amplitude-modulation format. A first amplitude regeneration, which involves reduction of amplitude noise, is applied to a first symbol pair. A modulation format conversion is performed on the optical signal in the phase/amplitude modulation format after the first amplitude regeneration. A second amplitude regeneration is applied to a second symbol pair, wherein the first and second symbol pairs differ from one another in respect of at least one different feature, which is selected from a group that includes a different nominal phase value assigned to the symbols of the symbol pair and a different temporal distance between the symbols of a symbol pair.

### RELATED APPLICATION DATA

The present application is a continuation of a U.S. provisional application Ser. No. 61/150,396, filed 6 Feb. 2009.

### FIELD OF THE INVENTION

The invention relates to regeneration of optically transmitted signals and particularly to regeneration of optically transmitted telecommunication signals encoded in BPSK (binary phase-shift keyed and QPSK (quaternary phase-shift keying) modulation formats as well as in variations of these formats, such as DPSK (differential phase-shift keying) and DQPSK (differential quaternary phase-shift keying).

### BACKGROUND OF THE INVENTION

In QPSK modulation, which is used as an illustrative but non-restrictive example for describing the invention, signal is transmitted in bit pairs. In other words, one symbol contains two bits of information. The four possible bit pairs are encoded into four different phase values, which can be absolute phase values or relative phase differences between two consecutive symbols. This is illustrated schematically in FIG. 1, wherein reference numeral 1-1 denotes a sequence of five optical pulses, each of which carries a symbol, in a diagram wherein t denotes time and I denotes signal intensity. The first pulse carries a symbol with a phase value of −3π/4, which signifies bit pair ‘00’. Reference numeral 1-2 denotes the bit pair values of the five pulses of the sequence 1-1. Reference numeral 1-3 denotes an idealized waveform in terms of intensity versus time. The idealized signal exhibits a normalized amplitude of one. Reference numeral 1-4 schematically represents the time-to-intensity relationship of real-world signals whose amplitude deviates from the nominal value, as shown by the two dashed lines 1-5.

Reference numeral 1-6 denotes an idealized constellation diagram, in which the radius of a circle denotes the amplitude of the optical pulse carrying the symbol (normalized as one), while the anti-clockwise angle from the real axis Re denotes phase. In the present modulation scheme, the nominal (ideal) phase values are π/4, 3π/4, −3π/4 and −π/4, which is why the constellation diagram 1-6 comprises only four points, which are the intersections of a unity-radius circle and the four possible phase angles. The relation between symbol pair values and phase angles in the constellation diagram 1-6 corresponds to Gray encoding, in which only one bit changes at a time with increasing phase value, but those skilled in the art will realize that the problem and its inventive solution are not restricted to any particular encoding scheme. Real-world optical transmission systems are not ideal, however, and the signal deviates from the idealized representation given in the diagram 1-6. Because of phase and amplitude noise, real-world optical transmission systems produce signals whose constellation diagrams resemble the one denoted by reference numeral 1-7.

BPSK modulation format is a subset of QPSK modulation. Instead of four different phase values, the BPSK modulation contains just two possible phase values, their relative phase difference being π radians. Consequently, BPSK modulation carries only one bit of information in each symbol.

As shown in the diagrams 1-1, the waveform's amplitude alternates from zero to unity (or to the noise-affected value 1-5) and back to zero for each symbol. This kind of amplitude variation is called return-to-zero (rz) amplitude modulation, but other modulation schemes are possible, such as non-return-to-zero (nrz) amplitude modulation. In many practical phase modulation formats the rz amplitude modulation is superimposed on top of the phase modulation. In such modulation schemes, it is not necessary for the amplitude modulation to carry net information (user information). Instead the amplitude modulation may carry a timing reference for demarcating the individual optical pulses that carry the symbols. Alternatively, the amplitude modulation may be used to reduce possible signal distortions, which may be caused by abrupt changes of signal phase. Within such modulation schemes, user information is typically carried by phase modulation. Later in this document, a phase-modulated signal means a signal in which user information is entirely or predominantly carried by variations in phase, whereas a phase/amplitude modulated signal means a signal in which user information is carried by variations in phase and amplitude.

FIG. 2 shows a BPSK regeneration circuit 2-0 described in reference 1 (“Johannison”). This circuit comprises a DPSK demodulator, a pair of 2R amplitude regenerators, and a DPSK modulator. The constructions of DPSK modulator and demodulator can be identical, both comprising two 3 dB couplers connected by two optical paths with unequal optical length between the optical paths. Specifically, the BPSK regeneration circuit 2-0 comprises a first delay interferometer 2-1, an amplitude regeneration section 2-2, and a second delay interferometer 2-3. The first delay interferometer 2-1 comprises a first 3 dB coupler 2-4, a first optical path 2-5A and a second optical path 2-5B, and a second 3 dB coupler 2-6.

The first and second optical paths 2-5A, 2-5B have different optical path lengths, and the difference is inversely proportional to the received symbol rate such that the phase modulated signal is transformed to an amplitude modulated signal. In effect, the optical path length difference equals the distance traveled by the optical signal in an optical medium in a time that corresponds to one symbol period, as known by those skilled in the art. The two outputs of the first delay interferometer 2-1 are connected to an amplitude regeneration section 2-2, which consists of two optical paths, each containing a non-linear optical element denoted 2R. The outputs of the non-linear optical elements are connected into the second delay interferometer 2-3, which has a similar structure to the first one and includes a third 3 dB coupler 2-7, a third optical path 2-8A, a fourth optical path 2-8B, and a fourth 3 dB coupler 2-9. The optical path length difference of the third optical path 2-8A and the fourth optical path 2-8B is in proportion to the transmitted symbol rate, similarly to the first optical delay interferometer 2-1. Johannison states that the regeneration circuit 2-0 can be simplified by omitting parts to the right of a dashed line 2-10 provided that a 3 dB power loss is acceptable.

As disclosed by Johannison, the amplitude regeneration section 2-2 comprises two “ideal reamplifying reshaping regenerators”, shown as the two non-linear elements denoted “2R”, wherein the two R's apparently stand for reamplifying and reshaping of an optical signal. Johannisson implements amplitude regeneration by means of an ideal amplitude-dependent filter, whose amplitude is one of two discrete values, ie, it is a step function. If the input amplitude is below a certain threshold value, the output amplitude is zero. If the input amplitude is above the threshold value, the output amplitude is set to the maximum amplitude for a noiseless case.

The amplitude regenerated signals of the two optical paths are directed into the first and second inputs of the third coupler 2-7 of the second delay interferometer 2-3. The third optical coupler 2-7 divides the two input signals into two parts, one part being coupled into a third optical path 2-8A and the other into a fourth optical path 2-8B. Due to the optical path length difference between the third and fourth optical paths 2-8A, 2-8B, the optical signal parts arrive at different times to a fourth optical coupler 2-9 such that the time difference is one symbol period and the recombined signal is thus a combination of the optical signal and the delayed optical signal. Given that the length difference of the two optical paths of the delay interferometer 2-3 is adjusted suitably to ensure a desired phase difference of the optical signal and the delayed optical signal, the BPSK regenerated optical signal exhibits constructive interference at the first output OUT of the fourth optical coupler 2-9 of the second delay interferometer 2-3, and the second output of the fourth optical coupler 2-9 exhibits destructive interference of the BPSK regenerated optical signal. As a result, the second output of the fourth coupler 2-9 outputs no optical power in case of an ideal input BPSK signal. It outputs optical power only in case of a noisy input signal. As described above, the circuit 2-0 regenerates the phase properties of the BPSK modulated signal.

FIG. 3 shows a BPSK regeneration circuit 3-0 described in reference 2 (“Grigoryan”). Within this document, the beginning of a reference numeral or sign generally indicates the Figure in which an element first appears; when that element is shown in later Figures, a detailed description is omitted. As shown in FIG. 3, the regeneration circuit 3-0 described by Grigoryan begins at block or section 2-1, which is structurally and functionally identical with the similarly-numbered block in FIG. 2. Similarly with the preceding circuit 2-0, the regeneration circuit 3-0 disclosed by Grigoryan comprises a first and second delay interferometer 2-1, 2-3, and Grigoryan's regeneration circuit 3-0 differs from the one disclosed by Johannison in respect of its amplitude regeneration section. Grigoryan's regeneration section 3-2 comprises two 3 dB couplers 321, 322 and two semiconductor optical amplifiers (labelled “SOA”, denoted by reference numerals 323 and 324).

In case of BPSK modulated signals, the two outputs of the coupler 2-6 of the delay interferometer contain complementary high and low amplitude signals, which are both directed to the couplers 321 and 322, which both couplers divide the signals and direct them to the SOA components. The high amplitude signals are thus propagating through the SOAs in one direction and the low amplitude signals are propagating through the SOAs to the opposite direction. When high and low amplitude signals cross an amplifying medium, and especially when the high amplitude signal saturates the gain of the amplifying medium, the low amplitude signal may experience a lower gain factor than the high amplitude signal. This means that the high amplitude signal is amplified relatively more than the low amplitude signal. Grigoryan teaches that this process is called discriminative gain. The non-linear amplifying element is thus having a characteristic comparable to saturable absorption, where the low amplitude level signal is suppressed when compared to the high amplitude level signal. After the SOAs the high and low amplitude level signals are recombined in the couplers 321 and 322. The optical arrangement of two 3 dB couplers and two connecting optical paths are known in the art as the Mach-Zehnder interferometer. In case of symmetric optical paths including the non-linear element, i.e., relatively similar characteristic of the optical paths, the Mach-Zehnder interferometer is known to direct the optical energy diagonally through the arrangement. In other words, the signal to the input 325 is directed to the output 328, while the signal to the input 326 is directed to the output 327. Therefore, in case of symmetric arrangement of couplers 321, 322 and optical paths containing the non-linear elements 323, 324, the high and low amplitude signals are directed to coupler 2-7 of the second delay interferometer 2-3, and not backwards to coupler 2-6 of the first delay interferometer 2-1.

While the layout of Grigoryan's amplitude regeneration section is different from Johannison's layout, it can be seen that the two regeneration circuits 2-0 and 3-0 share a common phase regeneration principle: a phase-modulated input signal, which suffers from phase noise, is applied to a first delay interferometer which converts the phase-modulated signal to an amplitude-modulated signal; after the phase-to-amplitude conversion the amplitude-modulated signal is regenerated. In case of the circuit 3-0, low amplitude levels are said to be suppressed in comparison with high amplitude levels by means of discriminative amplification; and after the discriminative amplification the signal is applied to a second delay interferometer which converts the regenerated signal back to a phase-modulated output signal, which exhibits less phase noise than the input signal does.

Yet another BPSK regeneration scheme is disclosed in reference 3 (“Wei”). Wei suggests a phase-sensitive amplifier for phase noise averaging of consecutive optical pulses. The regeneration scheme suggested by Wei is based on self-phase modulation in highly non-linear fibers. Similar to the regeneration schemes disclosed in references 1 or 2, Wei's technique is restricted to regeneration of BPSK-modulated signals. The scheme benefits of simple construction, but simulation experiments carried out by the inventors of the present invention have shown that the scheme is more susceptible to amplitude noise than the schemes disclosed in references 1 or 2, which may limit its usefulness in real-life transmission systems.

### BRIEF DESCRIPTION OF THE INVENTION

An object of the invention is to develop further improvements to the known regeneration circuits and methods. This object is achieved by apparatuses and methods as disclosed in the attached independent claims. The dependent claims and the present description with the attached drawings illustrate specific embodiments of the invention.

In order to keep the complexity of the description of the present invention within reasonable limits, the majority of the present description relates to modulation schemes in which all useful information is carried via phase modulation. The invention is not restricted to such modulation techniques, however, and later, in connection with some exemplary modulation formats, such as carrier-suppressed return-to-zero format and “duobinary” modulation format, it will be apparent that the invention is also applicable to modulation techniques in which useful information is carried partially via phase modulation and partially via amplitude modulation.

An aspect of the invention is an apparatus comprising at least one optical system having the following elements in the following sequence:
a first regeneration stage, a first inter-stage conversion element, and a second regeneration stage; wherein each of said elements has a first optical path and a second optical path, which traverse the element;
wherein the first regeneration stage is configured to receive an optical input signal carrying symbols in a first modulation format which is at least partially phase-modulated such that each symbol has a unique nominal phase value;
wherein the first regeneration stage comprises a first intra-stage conversion element configured to convert the symbols in the first modulation format to symbols in a second modulation format which is a phase/amplitude-modulation format such that each symbol has a unique combination of nominal phase value and nominal amplitude;
wherein each of the first regeneration stage and the second regeneration stage respectively comprises a first amplitude regenerator and a second amplitude regenerator configured to apply amplitude regeneration respectively to a first symbol pair and a second symbol pair, wherein the amplitude regeneration involves reduction of amplitude noise, and the first and second symbol pairs respectively regenerated by the first regeneration stage and the second regeneration stage differ from one another in respect of at least one different feature, which is selected from a group that comprises:
   a different nominal phase value assigned to the symbols of the symbol pair, and
   a different temporal distance between the symbols of a symbol pair; and
wherein the first inter-stage conversion element is configured to perform a modulation format conversion on an optical signal which is in the phase/amplitude-modulation format and which traverses the first inter-stage conversion element.

In the above definition of the inventive apparatus, a signal in the first modulation format, which is at least partially phase modulated means that useful information is carried wholly or partially via phase modulation. A phase/amplitude-modulated signal or a signal in phase/amplitude-modulation format means that useful information is carried partially via phase modulation and partially via amplitude modulation. As stated in connection with FIG. 1, amplitude fluctuations from zero to unity and back for each symbol period do not carry “information” as the term is used within this document. Instead the amplitude fluctuations from zero to unity and back carry a timing reference for demarcating the individual optical pulses that carry the information-carrying symbols (by means of phase modulation). The fact that each symbol has a unique nominal phase value was described in connection with FIG. 1, in which reference numerals 1-6 and 1-7 respectively denoted an idealized constellation diagram and a schematic real-life constellation diagram. In the example shown in FIG. 1, four different nominal phase values, namely π/4, −3π/4, −3π/4 and −π/4 were assigned to four different symbols. In the example of FIG. 1, those symbols were the bit pairs 11, 01, 00 and 10, respectively, but the invention is applicable to any mapping between symbols and phase values. In the exemplary real-life constellation diagram 1-7, within each of the four dot concentrations, all dots have the same nominal phase (namely π/4, 3π/4, −3π/4 and −π/4) but varying amounts of phase noise (as well as some amplitude noise).

As to the elements “intra-stage conversion element” and “inter-stage conversion element”, the stages refer to the first and second regeneration stages. “Amplitude regeneration” is a process which involves reduction of amplitude noise. “Conversion” is a process for changing an optical signal's modulation to a different modulation format. For instance, the optical signal can be converted from a phase-modulation format to a phase/amplitude-modulation format or vice versa. Or, the optical signal can be converted from a phase-modulation format or phase/amplitude-modulation format, respectively, to a different phase-modulation format or phase/amplitude-modulation format. An intra-stage conversion element is internal to one of the regeneration stages, while an inter-stage conversion element operates and resides between two regeneration stages. In sections wherein the optical signal is in the phase/amplitude modulation format, the optical signal propagates via two optical paths having complementary modulation with respect to one another.

The invention is at least partially based on the feature that the inventive apparatus comprises at least two regeneration stages. Said at least two regeneration stages regenerate mutually different symbol pairs, such that the symbol pairs differ from one another in respect of at least one different feature. That different feature can include a different nominal phase difference assigned to the symbols of the symbol pair. For instance, one regeneration stage can be configured to regenerate a symbol pair with phase difference values of 0 and π radians, while the other regeneration stage is configured to regenerate another symbol pair with phase difference values of −π/2 and π/2 radians. Alternatively or additionally, the different feature can include a different temporal distance between the symbols of a symbol pair. For instance, in one symbol pair the temporal distance between the symbols can correspond to a time period of two symbols, while in the other regeneration stage the temporal distance corresponds to a time period of one symbol. In some embodiments the regeneration stages can be similar to one another and the different feature between the symbol pairs regenerated by the regeneration stages is only apparent at the input to the inventive apparatus. The inter-stage conversion element separating the regeneration stages performs a modulation format conversion, as a result of which the regeneration stages regenerate mutually different symbol pairs even if the regeneration stages are substantially similar to one another.

The fact that the first inter-stage conversion element is configured to perform a modulation format conversion on the phase/amplitude-modulated optical signal traversing the first inter-stage conversion element means that during operation, the phase/amplitude-modulated signal proceeds from its input ports to its output ports, and the inter-stage conversion element applies a modulation format conversion to the phase/amplitude-modulated signal traversing it. In the modulation format transformation, when one symbol pair of the first phase/amplitude-modulated signal has nominal amplitude values of 0 or 1, this phase/amplitude-modulated signal is transformed to another phase/amplitude-modulated signal with a second symbol pair having nominal amplitude values of 0 and 1, wherein the phase difference of the second symbol pair differs from the phase difference of the first symbol pair.

Other aspects of the invention include a method comprising:
receiving an optical input signal carrying symbols in a first modulation format which is at least partially phase-modulated such that each symbol has a unique nominal phase value;
converting the symbols in the first modulation format to symbols in a second modulation format which is a phase/amplitude-modulation format such that each symbol pair has a unique combination of nominal phase value and nominal amplitude;
applying a first amplitude regeneration to a first symbol pair, wherein the amplitude regeneration involves reduction of amplitude noise;
performing a modulation format conversion on the optical signal into the second modulation format after the first amplitude regeneration;
applying a second amplitude regeneration to a second symbol pair, wherein the amplitude regeneration involves reduction of amplitude noise and wherein the first and second symbol pairs differ from one another in respect of at least one different feature, which is selected from a group that comprises a different nominal phase difference value assigned to the symbols of the symbol pair and a different temporal distance between the symbols of a symbol pair.

In a specific embodiment, the second regeneration stage is followed by a second inter-stage conversion element, which is configured to convert a phase/amplitude-modulated signal traversing the second regeneration stage to a phase-modulated signal. This optional feature helps to further reduce noise and to eliminate a delay difference between the two optical paths of the regenerator. This is beneficial in cases wherein the phase-modulated signal is transmitted further, such as in a fiber optical transmission system, and the modulation format is converted back to the original one.

In some cases, for example when the signal is terminated by photodiodes in an integrated receiver, it is not necessary to transform the regenerated signal back to its original modulation format. In such cases the apparatus may be implemented such that the second regeneration stage is not followed by a separate inter-stage conversion element. This implementation benefits from simpler construction.

In another specific embodiment, the first inter-stage conversion element is further configured to transform the optical signal which traverses the first inter-stage conversion element from a first phase/amplitude-modulation format to a second phase/amplitude-modulation format; the optical signal experiences constructive/destructive interference at a first symbol pair in the first phase/amplitude-modulation format and at a second symbol pair in the second phase/amplitude-modulation format experience; the first symbol pair and the second symbol pair exhibit respective phase angles which differ from one another by a predetermined amount. For instance, the inter-stage conversion element may utilize a coupler with two input arms and two output arms. The constructive/destructive interference is apparent in the fact that the two input arms receive signals having respective amplitudes of 1 and 0, and the signal with an amplitude of 1 experiences constructive interference, while the signal with an amplitude of 0 experiences destructive interference. In another example, both input arms may receive signals at an amplitude of 0.7, in which case the interference is neither purely constructive nor purely destructive but something in between these two extremes. The conversion elements may comprise one or more delay interferometers, which utilize interference properties of light.

The first and second amplitude regenerators may utilize amplitude-dependent amplification, such that a high-amplitude component of an optical signal is amplified more than a low-amplitude component of the optical signal. Or the amplitude regenerators may utilize amplitude-dependent attenuation configured to attenuate a low-amplitude component of an optical signal more than a high-amplitude component of the optical signal.

The amplitude regenerators typically comprise two optical paths each, and they are preferably configured to retain a phase relation between optical signals traversing in the two optical signal paths.

Noise reduction may be further improved by constructing the inventive apparatus such that it comprises two or more of the above-described optical systems, wherein each optical system comprises a first regeneration stage, a first inter-stage conversion element, and a second regeneration stage, as described above. The two or more optical systems are configured to regenerate different symbol pairs, such as symbol pairs having a different temporal distance between the symbols of a symbol pair.

In another specific embodiment, at least one amplitude regenerator is a coupled amplitude regenerator. As used herein, a coupled amplitude regenerator means an amplitude regenerator in which there is some coupling between the two signal paths within the amplitude regenerator. In contrast, the two signal paths of a non-coupled amplitude regenerator are not coupled to one another within the amplitude regenerator. A coupled amplitude regenerator provides the benefit over an uncoupled one that it is more readily implemented via limiting amplification (called discriminative amplification by Grigoryan). Limiting amplification tends to be faster than non-linear attenuation, which is the primary operating principle in connection with non-coupled amplitude regenerators. On the other hand, benefits of a non-coupled amplitude regenerator include simpler construction and better yield in manufacturing.

The inventive apparatus may be employed as a physically and logically distinct optical system, logically positioned between an optical demultiplexer and an optical receiver. Alternatively, the inventive apparatus may be integrated with an optical receiver such that the regeneration apparatus is configured to share at least one element, such as the first intra-stage conversion element with the optical receiver. Within the context of the present invention and its embodiments, integration means more than straightforward coupling of elements after one another, such that the integrated system brings about one or more benefits not provided by the straightforward coupling of elements. A prime example of such benefits is a reduction of system complexity.

### BRIEF DESCRIPTION OF THE DRAWINGS

In the following the invention will be described in greater detail by means of specific embodiments with reference to the attached drawings, in which

FIG. 1 schematically illustrates a QPSK modulation scheme, an ideal signal constellation and a signal constellation with a contribution from noise;

FIG. 2 shows a known phase regeneration scheme;

FIG. 3 shows another known phase regeneration scheme;

FIG. 4 shows a regeneration scheme for QPSK modulated signals, wherein two BPSK regenerators are coupled in a cascade arrangement such that the two regenerators regenerate symbol pairs with different nominal phase differences;

FIG. 5 shows a simplified version of the embodiment shown in FIG. 4;

FIG. 6 shows electric field amplitude and phase values at various output stages in the circuit shown in FIG. 5;

FIG. 7 is a set of constellation diagrams which further explains the operating principle of the embodiments shown in FIGS. 4 and 5, in connection with QPSK regeneration;

FIGS. 8 and 9 schematically show two probability distributions which indicate how the invention helps to reduce phase errors;

FIGS. 10, 11 and 12 show a comparison of a transmission function of a prior art nonlinear element with the transmission functions of some nonlinear elements used in specific embodiments of the present invention;

FIG. 13 shows an enhanced embodiment for QPSK or DQPSK operation, wherein two regeneration circuits shown in FIG. 5 are cascaded such that one regeneration circuit utilizes a two-bit delay interferometer and the other utilizes a one-bit delay interferometer;

FIG. 14 shows a simplified version of the embodiment shown in FIG. 13;

FIG. 15 shows a modification of the embodiment of FIG. 4, wherein the two non-coupled nonlinear elements have been replaced by coupled nonlinear elements;

FIG. 16 shows a simplified implementation of the embodiment shown in FIG. 15;

FIG. 17 illustrates how the embodiment shown in FIG. 16 can be further simplified;

FIG. 18 shows a further simplified version of the embodiment shown in FIG. 16;

FIG. 19 shows an embodiment in which the operating principle of the regeneration apparatus can be changed by means of a physical stimulus;

FIG. 20 illustrates techniques for implementing optical couplers having variable coupling ratios;

FIGS. 21A through 21C illustrate how an optical DPSK regenerator constructed with saturable absorbers can be integrated into an optical receiver;

FIG. 22 illustrates how an optical DPSK regenerator constructed with semiconductor optical amplifiers having limiting amplification can be integrated into an optical DPSK receiver;

FIG. 23 shows a known DQPSK receiver;

FIGS. 24A, 24B, 25A, 25B, 26A and 26B illustrate how an optical DQPSK regenerator constructed with saturable absorbers can be integrated into an optical DQPSK receiver;

FIG. 27 shows how an optical DQPSK regenerator constructed with semiconductor optical amplifiers having limiting amplification can be integrated into an optical DQPSK receiver; and

FIG. 28 illustrates determination of coupling ratio and phase shifts in a process of simplifying a passive Mach-Zehnder interferometer structure with a single coupler.

### DETAILED DESCRIPTION OF SPECIFIC EMBODIMENTS

FIG. 4 shows an embodiment for QPSK or DQPSK operation, wherein a first-stage regenerator 4-1 and a second stage regenerator 4-4 are coupled in a cascade arrangement such that the two regenerators regenerate symbol pairs with different nominal phase differences. Reference signs A and B generally denote the two signal arms of the arrangement. In the present embodiment, section or block 4-11 is a conversion element internal to the first stage regenerator, called herein an intra-stage conversion element. In the present embodiment it is implemented by means of a first delay interferometer, which comprises a first 3 dB coupler 411, a first optical path 4-11A, a second optical path 4-11B, and a second 3 dB coupler 413. The two optical paths 4-11A and 4-11B differ in optical path length by an amount which corresponds to a difference of one symbol period, as discussed above. As is known to those skilled in the art, structures involving interferometers are normally implemented such that the optical paths to be combined exhibit a phase shift which is substantially zero, unless specifically stated otherwise. As is well known to those skilled in the art, phase shifts are expressed modulo-2π radians. In other words, integer multiples of 2π radians can be added to or subtracted from the phase shift values expressed herein, without affecting the operation of the optical system. Generally speaking, the first intra-stage conversion element 4-11 performs a conversion from phase modulation to phase/amplitude modulation such that phase noise of the optical signal to the input IN is partially converted to amplitude noise, which is reduced by non-linear elements in block 4-12, which is a first amplitude regenerator, or an amplitude regenerator within the first-stage regenerator. In the example shown, the non-linear elements are implemented as saturable absorbers SA, denoted by reference numerals 414 and 415, but other implementations are possible, as will be described later, particularly in connection with FIGS. 10 to 12. The inter-stage conversion element 4-2 may be implemented as a simple 3 dB coupler 421. Further noise reduction may be achieved if the coupler 421 is followed by another coupler 423 and two optical paths 4-2A, 4-2B arranged to operate as an interferometer according to the same principle as the first intra-stage conversion element 4-11.

The first-stage regenerator 4-1 performs noise reduction on a first quadrant pair (say, with a phase difference of 0 and π radians), while the second-stage regenerator 4-4 regenerates the other quadrant pair (say, with a phase difference of +π/2 and −π/2 radians). Block 4-41 is a second intra-stage conversion element which is part of the second-stage regenerator 4-4. It comprises two couplers 443 and 446, which are interconnected by two optical paths 4-4A and 4-4B which differ in optical path length by an amount corresponding to one symbol period, and which additionally have a minute small optical path length difference corresponding to a phase shift of π/2 radians. In the present embodiment this phase shift can be controlled and adjusted by using a π/2 phase shifter 445. It is the task of the second intra-stage conversion element 4-41 to perform modulation format transformation from phase modulation to phase/amplitude modulation, such that the optical signal phase noise of the second symbol pair (say, with a phase difference of +π/2 and −π/2 radians) is partially converted to amplitude noise near the zero amplitude level. That amplitude noise, especially at low signal levels, is removed or reduced by the next block 4-42, which is a second amplitude regenerator which is part of the second-stage regenerator 4-4. In the present embodiment it is structurally similar to the first amplitude regenerator 4-12, and a detailed description is omitted. In the present embodiment the second inter-stage conversion element 4-5 comprises couplers 451, 454 which are interconnected by two optical paths 4-5A and 4-5B which differ in optical path length by an amount corresponding to one symbol period and which additionally have a minute optical path length difference corresponding to a phase shift of π/2 radians. In the present embodiment this phase shift can be controlled and adjusted by using another π/2 radian phase shifter 453.

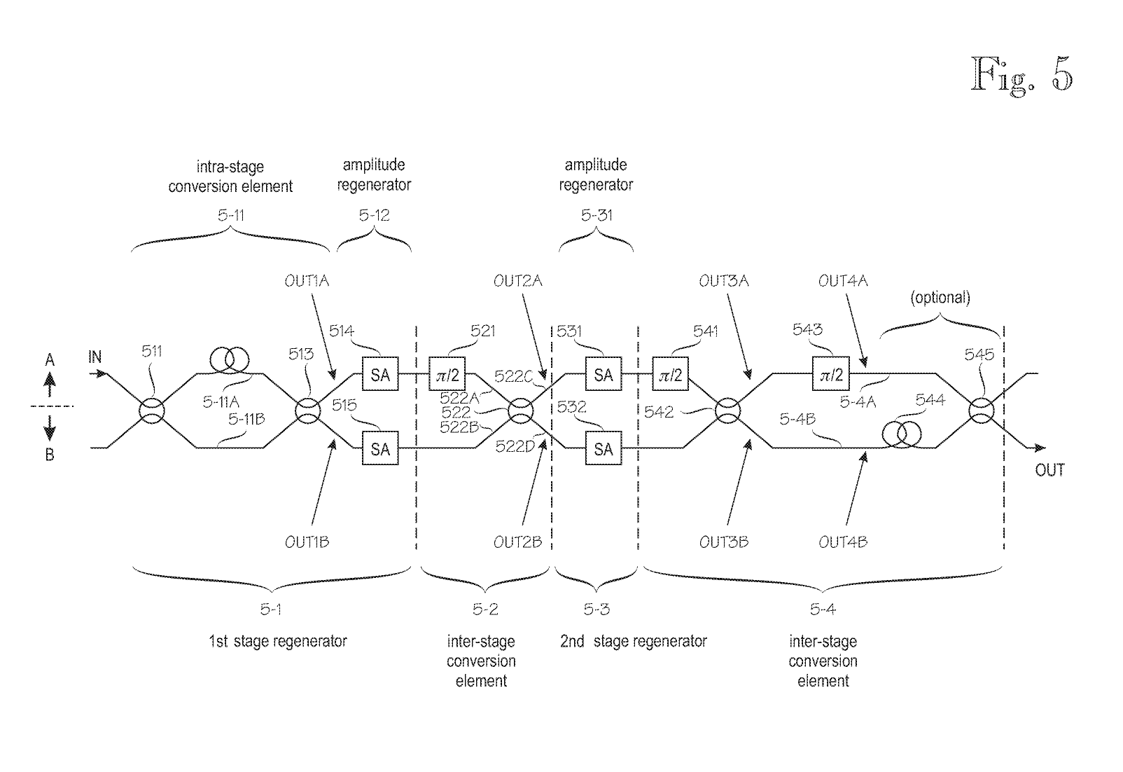

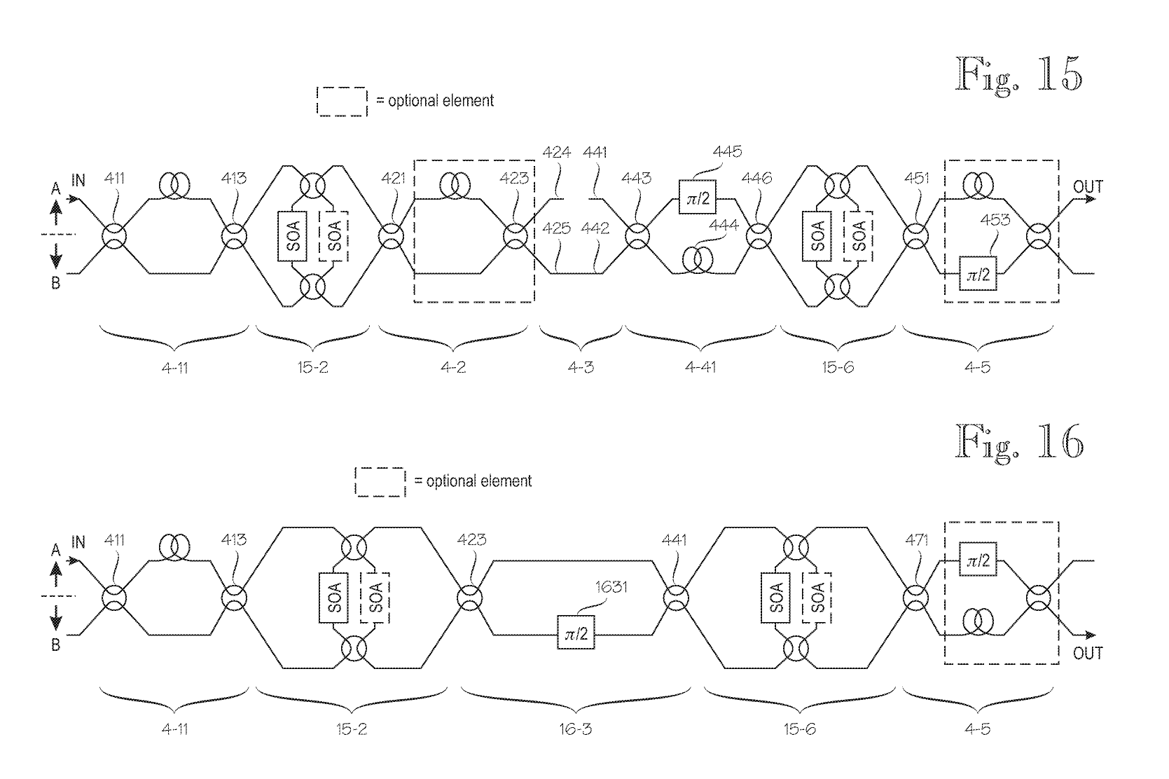

The block denoted by reference numeral 4-3 contains no active elements. Instead it only couples the two output arms 424, 425 of the first inter-stage conversion element 4-2 and the two input arms 441, 442 of the second intra-stage conversion element (block 4-41). One of the output arms (here the one denoted by reference numeral 425) produces predominantly noise and is normally left unconnected. However, if the output arm 425 from block 4-2 is coupled to the corresponding input arm 442 of block 4-41, thus injecting noise back into the circuit, the regeneration circuit shown in FIG. 4 can be simplified to the form shown in FIG. 5. The simplification process is discussed in more detail in connection of other embodiments which are shown in FIGS. 15 through 18.

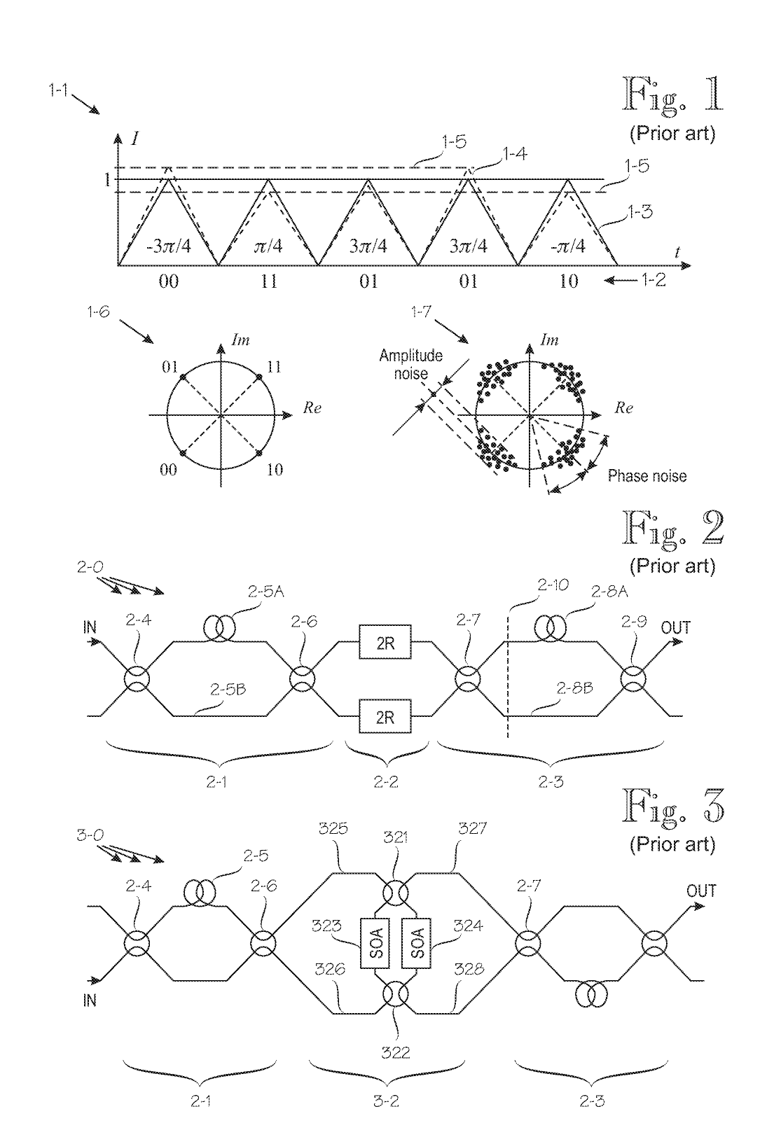

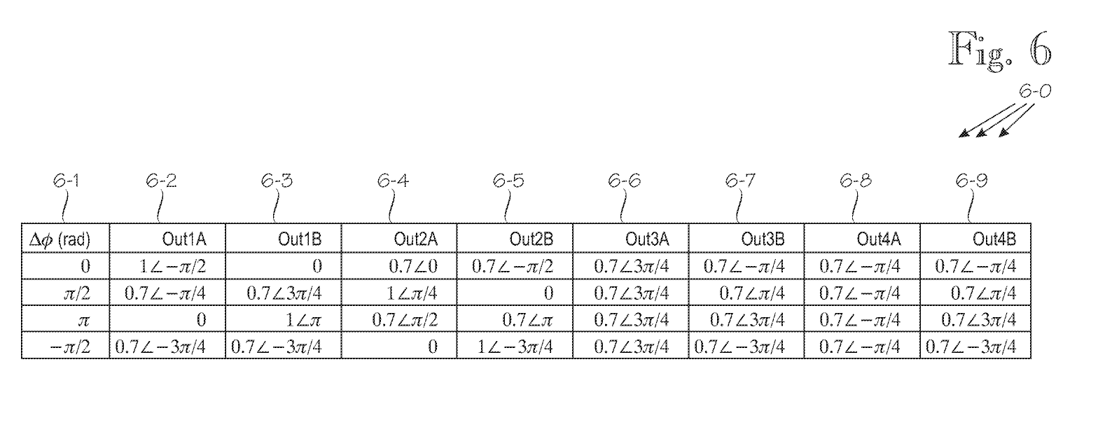

As regards circuit layout, the layout of the first stage 4-1) and inter-stage conversion element 4-2 or the second stage 4-4 and the second inter-stage conversion element 4-5 may be similar to the prior art layout shown in FIG. 2, but the ideal amplitude-dependent filter proposed by Johannisson cannot be used, because it “idealizes” all signal values by classifying the signals as either normalized values of 0 or 1. Instead the non-linear elements 414, 415; 447, 448 being employed in blocks 4-12 and 4-42 of the present embodiment only suppress the low-amplitude level signal, and thus remove noise at near-zero amplitude levels while leaving the signal, and thus also the noise at near-one amplitude levels intact as much as possible. Signal (and noise) at high amplitude levels must be preserved so that the noisy phase information of the second quadrant pair can be modulation-format transformed by appropriate inter-stage conversion elements to a phase-and-amplitude-modulated signal wherein some of the phase noise is transformed to amplitude noise near the zero level. Such amplitude noise is suppressed by the non-linear elements 447 and 448 of the amplitude regenerator 4-42 within the second-stage regenerator 4-4. The noise-reduction process will be further described in connection with FIGS. 6 to 12.

FIG. 5 shows a simplified version of the embodiment shown in FIG. 4. The simplified embodiment comprises four major blocks 5-1 through 5-4, which are a first-stage regenerator 5-1, a first inter-stage conversion element 5-2, a second-stage regenerator 5-3 and a second inter-stage conversion element 5-4. Similar to the embodiment shown in FIG. 4, the first-stage regenerator 5-1 comprises an intra-stage conversion element, denoted by reference numeral 5-11, and an amplitude regenerator, denoted by reference numeral 5-12, but the second-stage regenerator 5-3 of the present embodiment does not comprise an intra-stage conversion element. Rather it only comprises an amplitude regenerator, denoted by reference numeral 5-31. In the present embodiment, the second inter-stage conversion element 5-4 has two π/2 radian phase shifters 541, 543 in one of its optical paths (here: the A path) and a 3 dB coupler 542 between them. Reference numeral 544 denotes an optical path length difference corresponding to one symbol period between the two optical paths A and B, as was described in connection with FIG. 4. Another 3 dB coupler 545 couples the two optical paths.

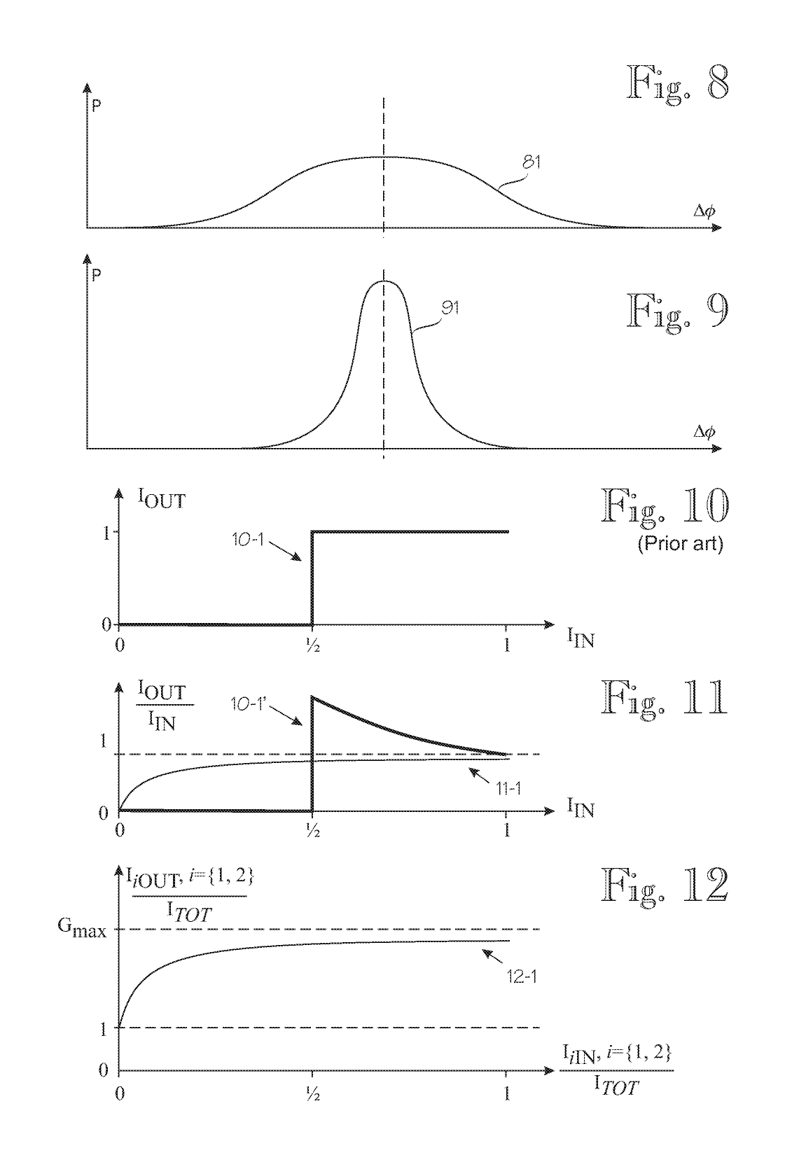

The intra-stage conversion element 5-11 of the first-stage regenerator 5-1 comprises a delay interferometer, which in turn comprises a first 3 dB coupler 511, a first optical path 5-11A, a second optical path 5-11B, and a second 3 dB coupler 513. The two optical paths 5-11A and 5-11B differ in optical path length by an amount which corresponds to a difference of one symbol period, as discussed above. The first-stage regenerator 5-1 also comprises an amplitude regenerator 5-12, which comprises nonlinear transmission elements denoted by reference numerals 514 and 515. They can be implemented as saturable absorbers (hence the acronym “SA”) but other implementations are also possible, as will be explained in elsewhere in this document and particularly in connection with FIGS. 11 and 12. The first inter-stage conversion element 5-2 contains a 3 dB coupler 522 having two inputs 522A, 522B, and two outputs 522C, 522D. The two optical paths connected to the inputs 522A and 522B differ in optical path length by an amount corresponding to a phase shift of π/2 radians. In the present embodiment this phase shift can be controlled and adjusted by using a π/2 phase shifter 521. Those skilled in the art will understand that the locations of the various phase shifters are purely exemplary, and any phase shift control may take place virtually anywhere along the optical path, including the non-linear saturable absorbers or SOA elements (semiconductor optical amplifier) which are part of the optical path. Or, the phase shift control may take place in a distributed manner. Any phase shift of a given sign (plus or minus) in one optical path (A or B) may be replaced by a phase shift of the opposite sign (minus or plus) in the other optical path (B or A).

The third major block 5-3 is a second-stage regenerator. In the present embodiment it only comprises an amplitude regenerator 5-31 which (in this example) is structurally identical with the amplitude regenerator 5-12 of the first-stage regenerator 5-1. As shown, it comprises two more saturable absorbers 531 and 532. The second-stage regenerator 5-3 is followed by a second inter-stage conversion element 5-4, which comprises a π/2 phase shifter 541 and a fourth 3 dB coupler 542. These elements are analogous with the corresponding elements 521, 522 of the first inter-stage conversion element 5-2. Similarly to the saturable absorbers 514, 515 of the first amplitude regenerator 5-12, the saturable absorbers 531, 532 of the second amplitude regenerator 5-31 eliminate noise near the zero amplitude level, while the two optical couplers 522, 542 whose input optical paths differ in optical path length by an amount corresponding to π/2 (modulo 2π) radians, perform an appropriately-dimensioned modulation format transformation, as described in connection with FIG. 4. The second inter-stage conversion element 5-4 comprises a delay interferometer having two optical paths 5-4A and 5-4B, which differ in optical path length from one another by an amount corresponding to one symbol period and a phase shift of π/2 radians. In the present embodiment this phase shift can be controlled and adjusted by using another π/2 phase shifter 543.

The embodiment shown in FIG. 5 comprises only components which are similar to those described in connection with FIG. 4, and a detailed description of the components is omitted. The schematic layout of the components and major functional blocks is apparent from FIG. 5, and a detailed description of the operation of these blocks will be provided in connection with FIG. 6.

FIG. 6 shows electric field values (amplitude and phase) at various points in the embodiment shown in FIG. 5, in a case wherein the input is assumed to be two consecutive symbols with electric field values of E1=A1*e^{iφ}^{₁} and E2=A2*e^{iφ}^{₂}, wherein A1, A2 are normalized amplitudes, A1=A2=1, φ₁=0 radians, and φ₂=is a variable. These points are denoted by OutnA and OutnB, wherein “n”=1, 2, 3 or 4, and stands for the point's position in the sequence. Reference numeral 6-0 denotes a table which indicates the values for the four outputs OutnA and OUTnB as a function of the phase difference Δφ=φ₁−φ₂ between two consecutive pulses. The phase difference Δφ, which is denoted by reference numeral 6-1, is the independent variable in the table 6-0. Columns 6-2 and 6-3 respectively indicate output values for the two outputs Out1A and Out1B of the first intra-stage conversion element 5-11. As indicated by columns 6-2 and 6-3, the amplitude of the electric field (which is proportional to the square root of intensity) may take a normalized value of 1, 0.7 or 0, in absence of amplitude or phase noise. The phase noise manifests itself as amplitude noise particularly at the low-amplitude level signals, especially at signals whose nominal amplitude value is zero.

As usual, notations like “1∠π/2” mean an amplitude A of unity at a phase angle φ of π/2 radians.

After the first intra-stage conversion element 5-11, the two signal arms denoted by reference signs OUT1A and OUT1B are coupled to the first inter-stage conversion element 5-2 whose outputs are labelled Out2A and Out2B. Columns 6-4 and 6-5 of the table 6-0 indicate output values for the two outputs Out2A and Out2B of the first inter-stage conversion element 5-2. As indicated by table 6-0, the quadrature pair having amplitude values of 0 and 1 is changed. This means that the treatment (regeneration) by the saturable absorbers can be repeated, while the originally treated quadrature pair is left intact as much as possible.

Columns 6-6 and 6-7 of the table 6-0 indicate output values Out3A and Out3B for the two outputs of the fourth 3 dB coupler 542.

Within the second inter-stage conversion element 5-4, the signal in one signal arm, denoted by reference sign OUT3A, is shifted by another π/2 phase shifter 543. The outputs Out4A and Out4B after the phase shifter 543 are indicated by columns 6-8 and 6-9 of the table 6-0.

The second inter-stage conversion element 5-4 may optionally comprise another 1-symbol delay interferometer, which comprises the two couplers 542, 545, the two mutually different optical paths 5-4A and 5-4B, a one-symbol delay element 544 and a fifth 3 dB coupler 545, and whose output OUT is nominally identical with the original pair 1∠0 and 1∠φ, but with a reduction of noise in both symbols. The second complete delay interferometer (including the couplers 542, 545 and the two optical paths 5-4A and 5-4B having a difference 544 in optical path length), is not absolutely necessary because the outputs Out4A and Out4B of the fourth 3 dB coupler contain the full original information in both of its optical paths, albeit with a one-symbol delay in respect with one another. The second complete delay interferometer including the elements 542, 544, 545 and one of the two optical paths, eliminates this one-symbol mutual difference and brings about a further reduction of noise.

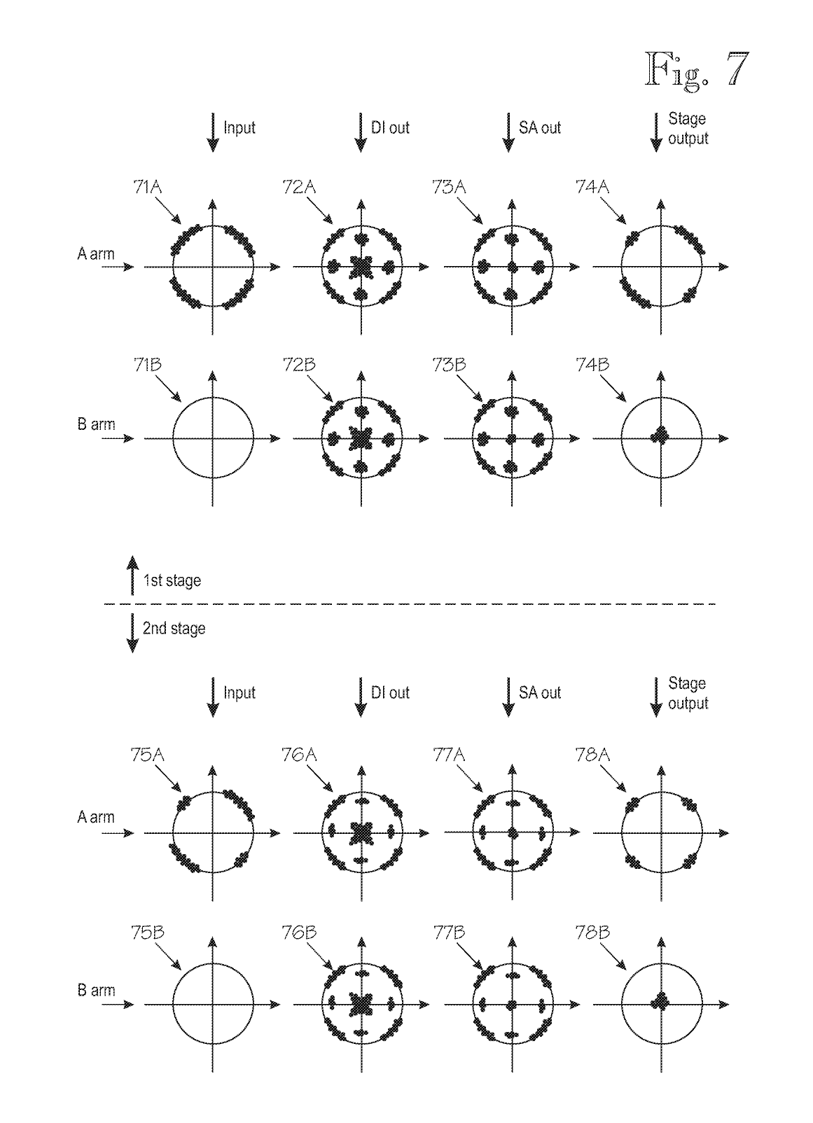

FIG. 7 is a set of constellation diagrams which further explains the operating principle of the embodiment shown in FIG. 4 in connection with DQPSK regeneration. With some adaptations, FIG. 7 is also applicable to the embodiment shown in FIG. 5. There are 16 constellation diagrams 71A to 78A and 71B to 78B. Reference signs ending in A or B relate, respectively, to the signal arms labelled A and B. Numbers 71 to 74 relate to the first stage and inter-stage conversion element, while the remaining numbers 75 to 78 relate to the second stage and inter-stage conversion element.

Numbers 71 and 75 relate to the stage input, numbers 72 and 76 to the output of the delay interferometer, abbreviated as DI. The delay interferometer is an exemplary implementation of an intra-stage conversion element. Numbers 73 and 77 relate to the outputs of the saturable absorbers (an exemplary implementation of an amplitude regenerator), while numbers 74 and 78 relate to the inter-stage conversion elements' outputs. For instance, reference numeral 77B denotes the constellation diagram at the output of the saturable absorber 448 in the second stage's B arm.

Reference sign 71A denotes the constellation diagram present at the input to the first stage and to the circuit as a whole. The constellation diagram comprises a circle that corresponds to an amplitude of one. As explained in connection with FIG. 1, this constellation diagram should ideally resemble diagram 1-6 of FIG. 1, but in practice it resembles the diagram 1-7. In the present example, nothing is connected to the B arm, which is why the constellation diagram 71B is empty. Reference numerals 72A and 72B denote constellation diagrams at the A and B arm outputs of the first delay interferometer, respectively (block 4-11 in FIG. 4). The delay interferometer transforms the phase-modulated signal to a phase/amplitude modulated signal. The quadrature pair's phase differences of 0 and π radians are transformed into nominal amplitude values of 0 and 1. Because of input signal phase noise, the transformed signals are distributed along the unity-amplitude circle and nominal 0-level amplitude signals deviate from the origin of the constellation diagram. The signals of other quadrature pair phase difference of π/2 and −π/2 radians are transformed into nominal amplitude values of 0.7, but due to input signal noise the constellation dots have some spread. Reference numerals 73A and 73B denote constellation diagrams after the first stage's saturable absorbers (block 4-12), which suppress weak amplitudes in comparison with stronger amplitudes, which traverse the saturable absorbers substantially unaffected. Accordingly, the dot cluster near the origin is diminished. Reference numerals 74A and 74B denote constellation diagrams at the output of the first inter-stage conversion element (block 4-2). The signal is now transformed back to a phase-modulated one and the regenerated symbol pair {1∠3π/4, 1∠−π/4}, while the other symbol pair {1∠π/4, 1∠−3π/4} is left virtually intact, including noise. As shown by constellation diagram 74B, the B output arm of the second delay interferometer outputs effectively only noise.

The noise from the second symbol pair {1∠π/4, 1∠−3π/4} is eliminated in the second stage, as shown by constellation diagrams 75A/B to 78A/B. Constellation diagrams 75A/B are present at the input to the second stage's first delay interferometer (block 4-41). Nothing is connected to the B arm, which is why the constellation diagram 75B is empty. The processing in the second stage is basically similar to the processing in the first stage, but by virtue of the two π/2 relative phase shifts in the delay interferometers 4-41 and 4-5 the noise is eliminated from the second symbol pair {1∠π/4, 1∠−3π/4}. Reference sign 78A denotes the constellation diagram present at the output of the circuit shown in FIG. 4. Reference sign 78B denotes the constellation diagram of the B arm of the second inter-stage conversion element's output, which represents essentially noise.

FIG. 7 is also applicable to the simplified embodiment shown in FIG. 5, with some modifications. Firstly, since two delay interferometers have been eliminated, the constellation diagrams 74A/B and 75A/B are not present, and constellation diagrams 73A/B are followed by constellation diagrams 76A/B. Secondly, the A and B labels of the two signal arms should be reversed in the diagrams 76A/B, 77A/B and 78 NB.

FIGS. 8 and 9 schematically show two probability distributions which indicate how the invention helps reduce phase errors. Reference numeral 81 denotes a probability distribution for differential phase error 4 before regeneration, while reference numeral 91 denotes the probability distribution after the inventive regeneration.

FIGS. 10, 11 and 12 show a comparison of a prior art nonlinear element with the nonlinear elements used in some embodiments of the present invention. As stated earlier, in connection with FIG. 2, Johannisson implements regeneration by means of an ideal amplitude-dependent filter, whose amplitude is one of two discrete values, ie, it is a step function. If the input amplitude is below a certain threshold value, the output amplitude is zero. If the input amplitude is above the threshold value, the output amplitude is set to the maximum amplitude for a noiseless case, and the threshold value is half of this amplitude value. Curve 10-1 graphically depicts the output intensity I_{OUT} as a function of the input intensity I_{IN} in the ideal amplitude-dependent filter described by Johannisson.

FIGS. 11 and 12 schematically show various curves of transmission (or gain or absorption) as a function of input intensity I_{IN}. Note that while the y axis in FIG. 10 reflects output intensity I_{OUT} as a function of I_{IN}, in FIG. 11 the y axis reflects the ratio I_{OUT}/I_{IN} as a function of I_{IN}. Curve 10-1′ in FIG. 11 provides exactly the same information as curve 10-1 in FIG. 10. This is the I_{OUT}/I_{IN} dependency of Johannisson's ideal amplitude-dependent filter. The I_{OUT}/I_{IN} dependency (gain) remains zero or close to zero for all I_{IN} values up to one half of the maximum input value, which is normalized as 1. When the input intensity I_{IN} reaches one half of the maximum value, the output intensity jumps to unity. Thus Johannisson's ideal amplitude-dependent filter has a gain of two for an input value of ½. As the input value approaches 1, the gain also approaches unity.

It is worth noting that the “ideal amplitude-dependent filter” disclosed by Johannisson, namely an element removes amplitude noise both at low amplitudes and high amplitudes, is unsuitable for some embodiments of the present invention in which two DPSK regenerators are cascaded after one another, such that one DPSK regenerator regenerates one quadrant phase difference pair (say, 0 and π radians), while the other regenerates the other quadrant phase difference pair (say, +π/2 and −π/2 radians). Curves 11-1 and 12-1 schematically depict transmission, gain or absorption as a function of input intensity I_{IN} for such cascade embodiments. Curve 11-1 illustrates the I_{OUT}/I_{IN} dependency of a saturable (nonlinear) absorber, while curve 12-1 illustrates the I_{OUT}/I_{IN} dependency of a saturable (nonlinear) amplifier. In FIG. 12, the x-axis represents I_{iIN}, i={1,2}/I_{TOT}, wherein I_{1IN}, I_{2IN} are the input intensities of the two opposite direction propagating signals to non-linear amplifying element, such as the two saturable SOA components and I_{TOT}=I_{1IN}+I_{2IN} is the sum of the input signals traversing the non-linear amplifying element. For the saturable absorber, the I_{OUT}/I_{IN} dependency 11-1, namely transmission, is very low (ideally zero) for small values of I_{IN}, and for larger I_{IN} values, the transmission approaches unity. On the other hand, for the saturable amplifier, the I_{OUT}/I_{IN} dependency 12-1, namely gain, begins ideally at unity for small values of I_{IN}, and for larger I_{IN} values, the gain approaches some maximum gain G_{MAX}, which is higher than unity.

It is customary to use the terms “absorption” and “gain” when referring to I_{OUT}/I_{IN} ratios below and above unity, respectively. In order to have a term applicable to ratios below as well as above unity, terms like “transmission” or “transmission ratio” will be used as a term which encompasses both absorption and gain. It can be seen from FIGS. 10 and 11 that the transmission of Johannisson's ideal amplitude-dependent filter is symmetric in respect of the I_{IN} value of ½, and thus eliminates amplitude noise for both low and high amplitude values. In other words, near-zero values are “cleaned” to zero and near-unity values are “cleaned” to unity. The transmission curves 11-1 and 12-1 proposed for the cascade embodiments of the present invention exhibit more relative suppression near the zero level and less relative suppression for near-unity input values (assuming that the input range is normalized as 0 to 1). In other words, the nonlinear transmission elements used in the cascade embodiments of the present invention eliminate amplitude noise only at low amplitude values but preserve signal and thus also noise at high amplitude values.

It is worth noting that the invention is not restricted to embodiments, which employ saturable absorbers as their nonlinear transmission elements. Instead, the nonlinear transmission elements can be implemented as nonlinear amplifiers, and this implementation brings about certain benefits. For instance, amplification compensates for losses that occur in the optical paths, which is why a regenerator utilizing amplifiers instead of absorbers may have zero insertion loss or even some net gain, whereas absorber-based implementations are bound to exhibit some insertion loss. Another benefit is that some nonlinear elements, particularly semiconductor optical amplifiers, operate faster as amplifiers than they do when operating as absorbers. At the time when the present invention was made, state-of-the-art semiconductor optical amplifiers had gain recovery times of approximately 10 ps, whereas the carrier recovery time (which affects absorption recovery) was typically 30 to 100 ps.

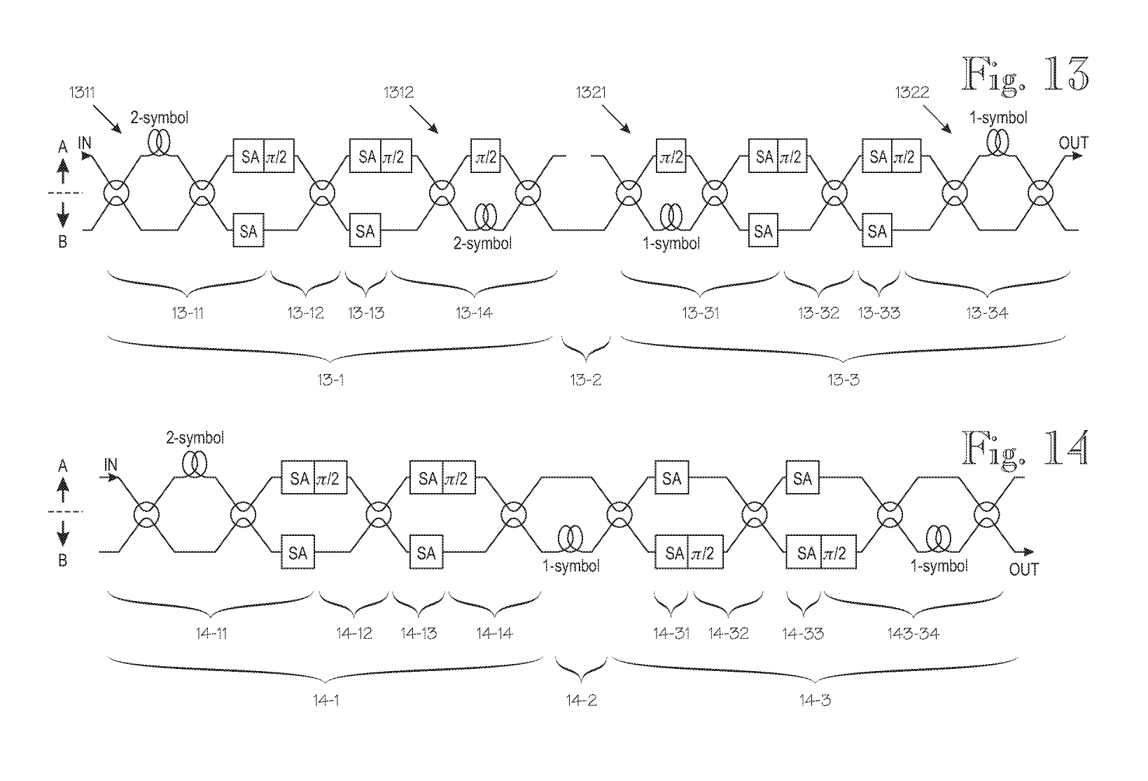

FIG. 13 shows an enhanced embodiment for QPSK or DQPSK operation, wherein two regeneration circuits shown in FIG. 5 are cascaded such that one regeneration circuit utilizes two-symbol delay interferometers and the other utilizes one-symbol delay interferometers. Specifically, the embodiment shown in FIG. 13 can be divided into two major sections 13-1 and 13-3 which are joined by a passive coupling section 13-2. In the present embodiment, each of the two major sections 13-1 and 13-3 is structurally similar to the circuit shown in FIG. 5, and the sections 13-1 and 13-3 each comprise a first-stage regenerator 13-11, 13-31, a first inter-stage conversion element 13-12, 13-32, a second-stage regenerator 13-13, 13-33 and a second inter-stage conversion element 13-14, 13-34. The difference between the two major sections 13-1 and 13-3 is that the first major section 13-1 employs 2-symbol delay elements 1311, 1312, while the second major section 13-2 employs 1-symbol delay elements 1321, 1322. In the present embodiment, the first major section 13-1, including the two-symbol delay interferometers 1311 and 1312, reduce phase noise apparent at 2-symbol differences, while the second major section 13-3, including the one-symbol delay interferometers 1321 and 1322, reduce phase noise apparent at 1-symbol differences. For a detailed description of the layout, sections, components and operation, a reference is made to FIGS. 5 and 6.

FIG. 14 shows a simplified version of the embodiment shown in FIG. 13. The reference numerals in FIGS. 13 and 14 are coordinated such that element 14-nn in FIG. 14 generally corresponds to element 13-nn in FIG. 13, and only the differences are described herein. The embodiment shown in FIG. 14 differs from the one shown in FIG. 13 in that the second 2-symbol delay interferometer 1312 from block 13-14 has been replaced by a 1-symbol delay interferometer and some of the optical paths have been omitted. In addition, the phase difference between the two optical paths A and B has been set to zero. In this respect, FIG. 14 shows an embodiment of the invention, wherein the first and second regeneration stages only differ from one another in respect of a temporal distance between the two symbol pairs regenerated by the two regeneration stages. In other words, the invention is not restricted to regenerating optical signals in quadrature modulation. This feature can also be implemented in connection with BPSK and DPSK regenerators.

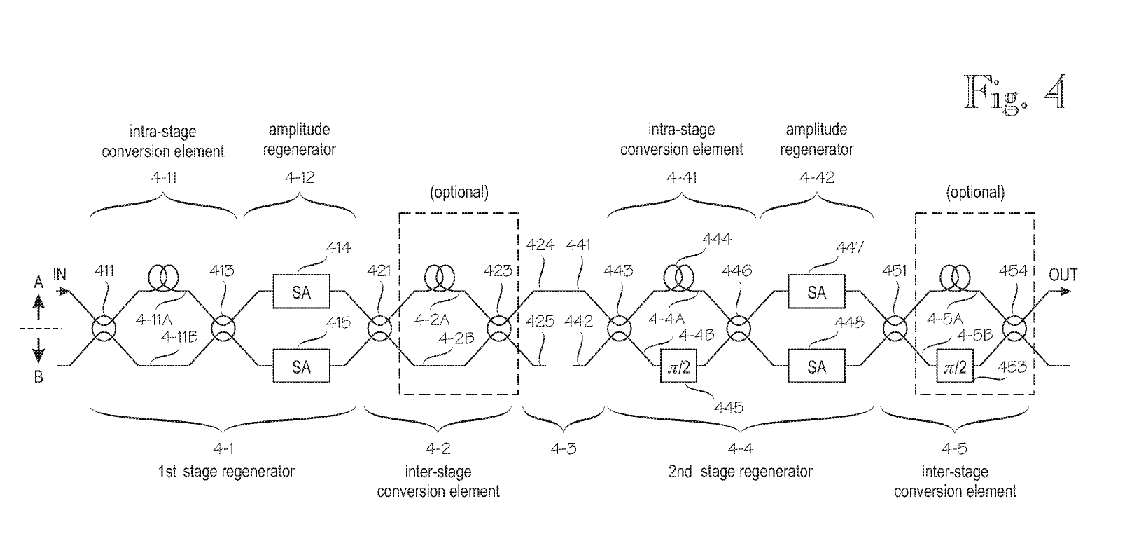

FIGS. 15 to 18 show how non-coupled nonlinear elements can be replaced by coupled nonlinear elements. In the description of the prior art in this document, FIG. 2 showed a known regenerator in which the nonlinear element (block 2-2) is a non-coupled element, which means that within the nonlinear element, the two signal arms A and B do not interact with one another. On the other hand, FIG. 3 showed a known regenerator in which the nonlinear element (the semiconductor optical amplifiers, “SOA”, in block 3-2) is implemented such that the two signal arms A, B do interact with one another. The regenerator shown in FIG. 3 thus employs a coupled nonlinear element. FIGS. 2 and 3 have been deliberately drawn in a manner which helps to identify their common features and differences, although no such teaching is actually provided by the prior art. A comparison of FIGS. 2 and 3 suggests that the coupled nonlinear element (shown as block 3-2 in FIG. 3) may be substituted for the non-coupled elements labelled SA in the previously-described embodiment (items 414, 415; 447, 448 in FIG. 4; 514, 515; 531, 532 in FIG. 5, as well as the corresponding SA elements in FIGS. 13 and 14).

FIG. 15 shows a modification of the embodiment of FIG. 4, wherein the two non-coupled nonlinear elements, shown as blocks 4-12 and 4-42, have been replaced by coupled nonlinear elements, denoted by reference numerals 15-2 and 15-6, respectively. Reference numerals beginning with “4” denote elements identical to their counterparts in FIG. 4, and such elements will not be described again. For a detailed description of the coupled nonlinear elements 15-2 and 15-6, a reference is made to the description of block 3-2 in FIG. 3.

FIG. 15 also comprises another modification in respect to FIG. 4, which results from the replacement of the non-coupled elements by their coupled counterparts. The other modification is that the A and B optical paths in blocks 4-3 and 4-41 are reversed in order, in that only the B arm output 425 of the first stage is connected to the corresponding input 442 of the second stage, and block 4-41 accordingly has the delay in the optical path 444 in its B arm, while the phase shift 445 is shown in the A arm. As stated in connection with FIG. 5, the shown locations of the various phase shifters are intended to illustrate a specific implementation of the present embodiment, and many other equivalent implementations are possible. Such minor modifications are possible in connection with other embodiments as well, and they are well within the scope of the appended claims.

As shown in FIG. 15, each of the two nonlinear elements 15-2 and 15-6 comprise two semiconductor optical amplifiers labelled SOA. The embodiment shown in FIG. 15 can be simplified by omitting one SOA component from one or both of the nonlinear elements 15-2 and 15-6. Omission of one SOA component causes approximately a 6 dB loss in signal amplitude, but this is normally not crucial because signal intensity is sufficiently high in connection with typical optical amplifiers. Thus the number of SOA components can be halved, not only in the present embodiment but in all embodiments employing SOA components in coupled nonlinear elements. However, embodiments in which a coupled nonlinear element is implemented with only one SOA component may benefit from the addition of optical isolators before the coupled nonlinear element, as will be described in more detail in connection with FIG. 18.

FIG. 16 shows a simplified implementation of the embodiment shown in FIG. 15. The simplifications are similar to those described in connection with FIG. 5, which showed a simplified implementation of the embodiment shown in FIG. 4, and a detailed description is omitted. Similarly to the previous embodiment, there is an inter-stage conversion element, shown as block 16-3, which comprises a π/2 phase shift 1631 between the optical paths A and B. As explained in connection with FIG. 4, the purpose of the π/2 phase shift 1631 is to enable the two substantially similar stage regenerators 15-2 and 15-6 to regenerate two symbol pairs having a mutual phase difference of π/2 radians (in modulo 2π, as usual).

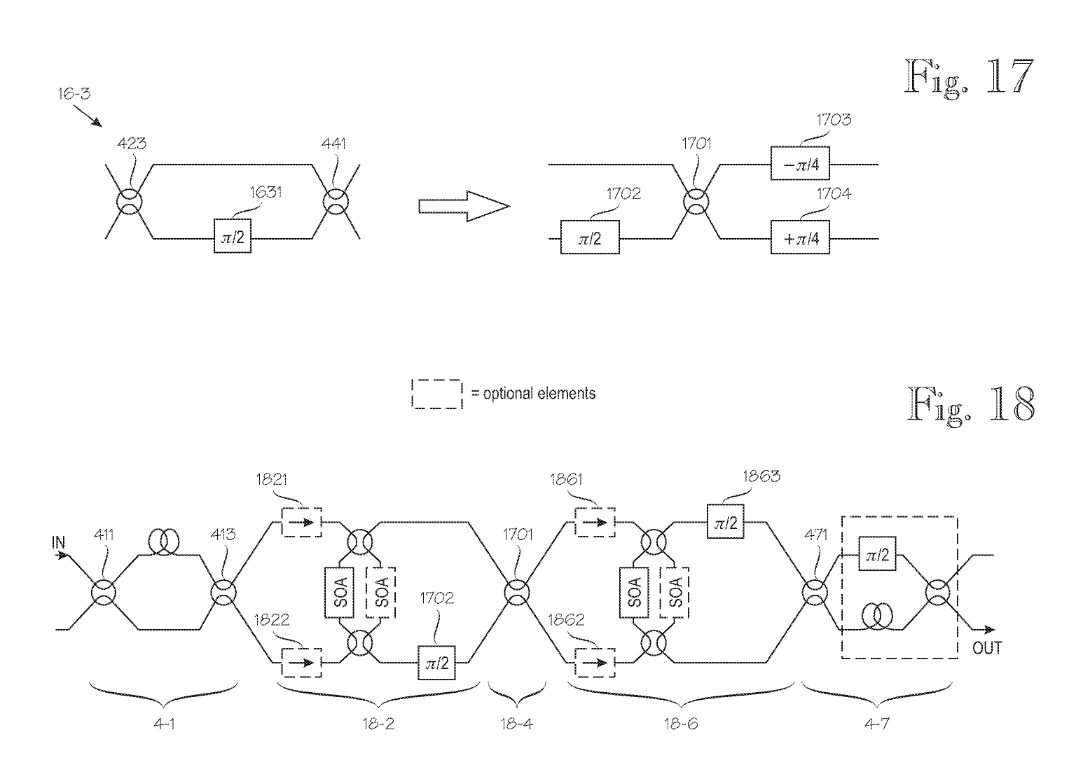

FIG. 17 illustrates how the embodiment shown in FIG. 16 can be further simplified. In FIG. 16, the first and second stages are connected by block 16-3, which can be identified as a Mach-Zehnder interferometer, having two 3 dB couplers 423 and 443, plus a π/2 phase shifter 1631 in one of its arms. The right-hand side of FIG. 17 shows an equivalent circuit for the Mach-Zehnder interferometer, which has only one coupler 1701. The other coupler has been eliminated by implementing the phase shifting in a distributed manner, via a π/2 phase shifter 1702, a −π/4 phase shifter 1703 and a π/4 phase shifter 1704.

FIG. 18 shows a further simplified version of the embodiment shown in FIG. 16. The present embodiment implements the simplification described in connection with FIG. 17. Furthermore, the two ±π/4 phase shifters 1703, 1704 have been combined into a single π/2 phase shifter 1863. Similarly to FIGS. 15 and 16, each of the two coupled nonlinear elements 18-2 and 18-6 can be implemented with only one SOA component in cases wherein a 6 dB loss in signal amplitude can be tolerated. In addition to the 6 dB signal amplitude loss, elimination of one SOA component from a supposedly symmetrical pair of SOA components disrupts circuit symmetry, which causes some reflection of signal energy back towards the preceding stages. As was briefly stated in connection with FIG. 15, such embodiments may benefit from the addition of optical isolators in front of each coupled nonlinear element implemented with only one SOA component. In FIG. 18, reference numerals 1821, 1822 and 1861, 1862 denote such optical isolators. An optimal compromise between circuit complexity and performance may be achieved by installing only the latter pair of optical isolators 1861, 1862, because signal energy reflected from the second regeneration stage 18-6 may lower the performance of the first regeneration stage 18-2. Those skilled in the art will realize that optical circulators can be substituted for the isolators, if so desired.

The embodiments shown in FIGS. 4, 5, 13 and 14 comprise non-coupled regeneration elements, while the embodiments shown in FIGS. 15 to 18 perform regeneration by means of coupled regeneration elements. Some embodiments of the invention are based on the idea that the division between coupled and non-coupled regeneration elements need not be fixed at manufacturing stage.

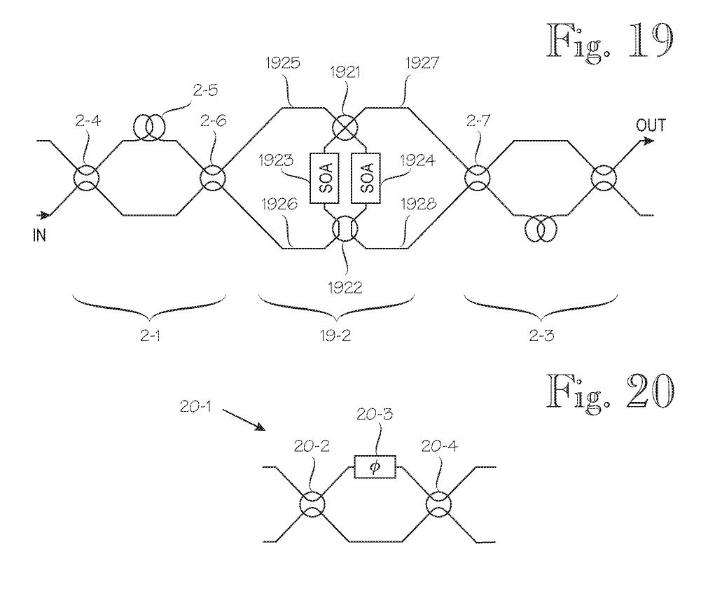

FIG. 19 shows an embodiment in which the operating principle of the regeneration apparatus can be changed by means of a physical stimulus. Within the optical element shown in FIG. 19, the sections 2-1 and 2-3 contain delay interferometers which can be similar to those described in connection with FIG. 2, and a detailed description is omitted. The middle section 19-2 is a regeneration section whose layout resembles the layout of the system shown in FIG. 3, and the semiconductor optical amplifiers (SOA elements) 1923, 1924, can be similar to the SOA elements described in connection with FIGS. 3, 10, 15, 16, 18. However, the regeneration section 19-2 differs from the one shown in FIG. 3 in that the two couplers denoted by reference numerals 1921 and 1922 are not fixed 3 dB (or 50:50) couplers. Instead the couplers 1921 and 1922 are dynamic couplers whose coupling ratio can be varied by means of a physical stimulus.

Within the embodiment shown in FIG. 19, the first coupler 1921 is shown in a state wherein the coupling ratio is 0:100 (full cross-coupling), while the second coupler 1922 is shown in a state wherein the coupling ratio is 100:0 (full bar-coupling or bar-state). Such couplers may be called three-state switches or multi-state switches, and the most interesting coupling ratios are 0:100, 50:50 and 100:0. Techniques for implementing such variable couplers will be described in connection with FIG. 20.

Even if the layout of the optical element shown in FIG. 19 resembles the layout of the coupled system shown in FIG. 3, when the couplers 1921, 1922 are in the two states shown in FIG. 19 (namely in full cross-coupling state and full bar-coupling state, respectively) it can be seen that the operating principle of the optical element shown in FIG. 19 is actually closer to that of the non-coupled system shown in FIG. 2. The regeneration section 19-2 has two SOA elements 1923, 1924 positioned in two optical paths with equal optical lengths. These optical paths cross each other such that signal energy applied to input 1925 is directed to output 1928, while signal energy applied to input 1926 is directed to output 1927.

FIG. 20 relates to techniques for implementing optical couplers having variable coupling ratios. FIG. 20 shows an optical element (or a segment of an optical element) 20-1, comprising a Mach-Zehnder interferometer. The Mach-Zehnder interferometer comprises a first coupler 20-2, a tunable phase-shifter 20-3 and a second coupler 20-4. The phase shift caused by tunable phase-shifter 20-3 is denoted by φ. With φ=±π/2 (modulo 2π) radians, the Mach-Zehnder interferometer acts as a 3 dB coupler (coupling ratio 50:50), with φ=±π (modulo 2π) radians, it is a bar-state coupler (coupling ratio 100:0) and with φ=0 (modulo 2π) radians, it implements full cross coupling (coupling ratio 0:100).

In the embodiment shown in FIG. 19, the multi-state couplers 1921, 1922 only exhibit two states, namely full cross-coupling and full bar-coupling state. Thus full three-state operating capability is not actually necessary. In some implementations, the couplers can be similar, with a 3 dB coupling state and either a bar-coupling state or cross-coupling state. In this case, connections to one coupler on either the input side or output side need to be crossed to achieve the optical element shown in FIG. 19.

FIGS. 19 and 20 illustrate schematic diagrams, and in real-world implementations it may turn out that that the two optical paths of the regeneration section (one optical path involving elements 1925, 1924 and 1928 and the other involving elements 1926, 1923 and 1927) differ from one another in optical path lengths. A tunable phase-shifter (not shown) can be added to one of the optical paths in order to restore parity between the optical path lengths. The optical distances between the couplers 2-6 and 2-7 should be substantially the same for all of the optical paths.

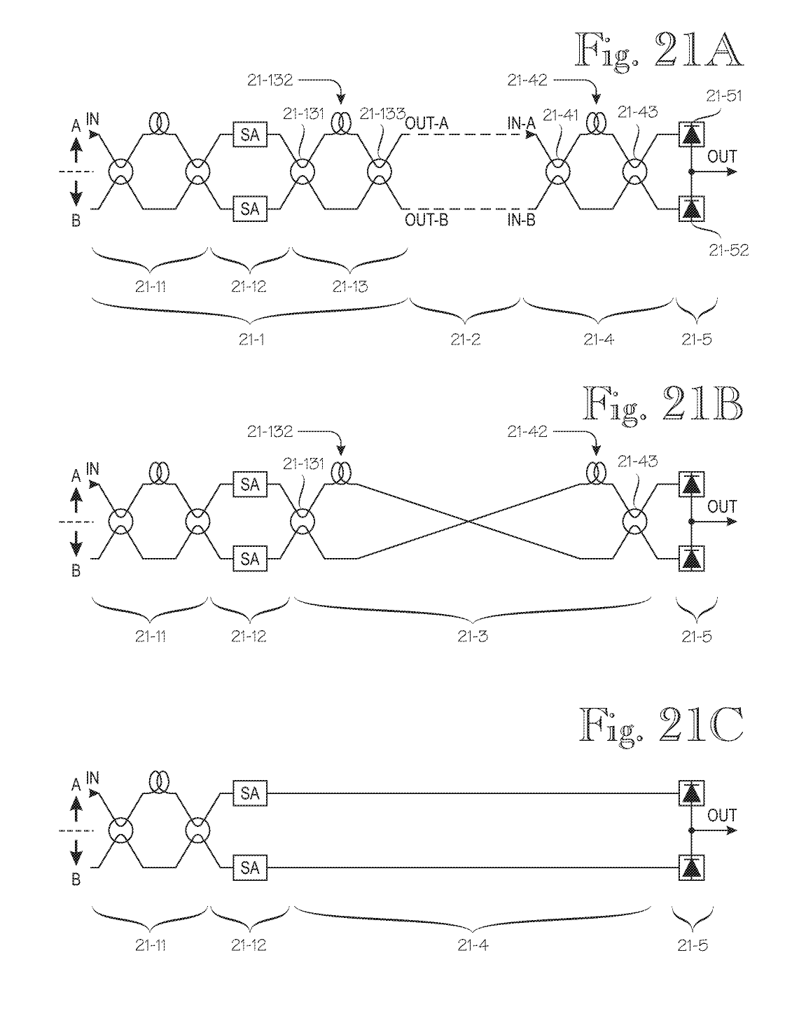

FIGS. 21A through 21C illustrate how an optical DPSK regenerator constructed with saturable absorbers can be integrated into an optical DPSK receiver. In FIG. 21A, reference numeral 21-1 denotes the optical DPSK regenerator constructed according to the above description of the present invention and its embodiments. The optical DPSK regenerator 21-1 comprises an intra-stage conversion element 21-11, which is substantially similar to the corresponding element 4-11 in FIG. 4, and a detailed description is omitted. Likewise, the amplitude regenerator section 21-12 and the inter-stage conversion element 21-13 can be similar to the respective elements 4-12 and 4-2 in FIG. 4. Reference numerals 21-4 and 21-5 denote sections which constitute the optical DPSK receiver. Section 21-4 is an optical interferometer which comprises a first 3 dB coupler 21-41 and a second 3 dB coupler 21-43. The 3 dB couplers 21-41 and 21-43 are connected by two optical paths of unequal length, as denoted by reference numeral 21-42. Reference numeral 21-5 denotes a detection section which terminates the optical DPSK receiver, at least for the purposes of describing the present invention and its embodiments. The detection section 21-5 comprises two photodetectors 21-51 and 21-52, such as photodiodes or other comparable devices as known in the art.

As regards the optical elements, the optical DPSK receiver denoted by reference numerals 21-4 and 21-5 can be conventional. However, in conventional DPSK receivers, only one input is used, such as the input labelled IN-A. Similarly, when the basic two-stage optical regenerator shown in FIG. 4 is used, only one output (“OUT”) is normally used, since the other output produces substantially only noise. It was stated in connection with FIGS. 13 through 18 that some savings in system complexity can be achieved by employing both output arms of the regenerator. That same teaching can be applied to the integration of the optical DPSK regenerator with the optical DPSK receiver. Specifically, reference numeral 21-2 denotes a connection section which couples both output arms OUT-A and OUT-B of the optical DPSK regenerator 21-1 to the respective inputs IN-A and IN-B of the optical DPSK receiver's first section, namely the interferometer 21-4.

It can be seen that both the optical regenerator's last interferometer 21-13 and the optical receiver's first (and only) interferometer 21-4 contain two optical paths of unequal length, as denoted by respective reference numerals 21-132 and 21-42. The two unequal optical paths and any elements between them can be simplified into the section denoted by reference numeral 21-3 in FIG. 21B. Since the section 21-3 is symmetrical in respect of the two optical paths, the section 21-3 can be replaced by a simple connecting section 21-4, as shown in FIG. 21C.

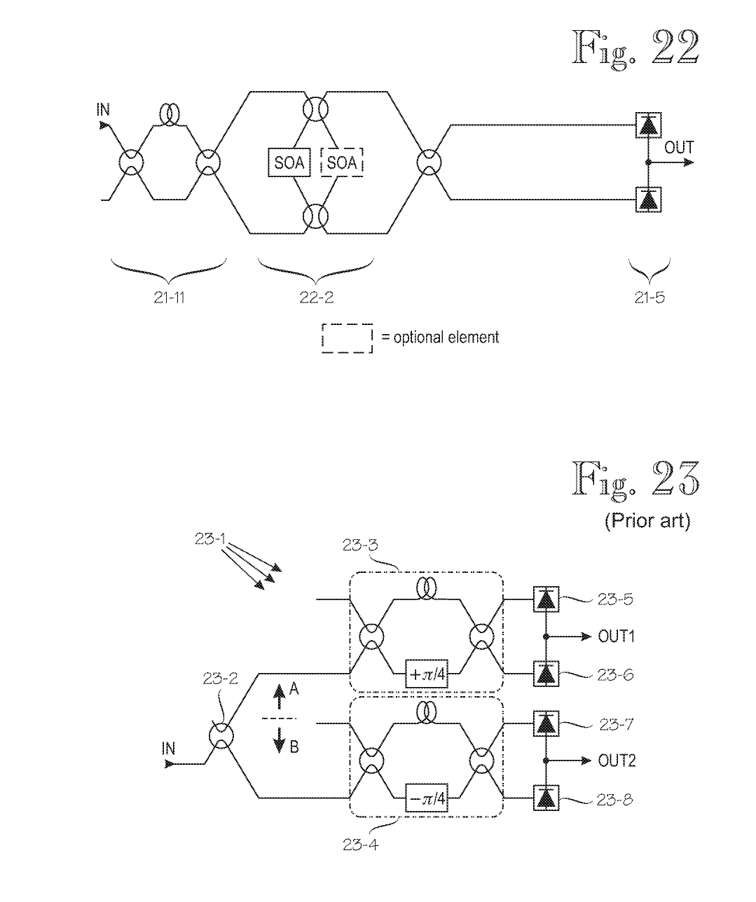

FIG. 22 illustrates how an optical DPSK regenerator constructed with semiconductor optical amplifiers having limiting amplification can be integrated into an optical DPSK receiver. As shown in FIG. 22, the integration results in an optical system having a first intra-stage conversion element 21-11, which can be similar to the corresponding element in FIG. 21, and an amplitude regenerator section 22-2, which can be similar to the corresponding elements 3-2, 15-2 or 19-2 in respective FIG. 3, 15 or 19, and a detailed description is omitted. The optical detection section 21-5 can be similar to the corresponding element shown in FIG. 21.

FIG. 23 shows a known DQPSK receiver generally denoted by reference numeral 23-1. The DQPSK receiver 23-1 comprises a first 3 dB coupler 23-2, which splits the signal applied to the input IN into two optical paths A and B. Each of the optical paths A, B is applied to a respective interferometer 23-3, 23-4. As regards layout, the interferometers 23-3, 23-4 can be similar to the section 4-5 described in connection with FIG. 4. The interferometers 23-3, 23-4 exhibit mutually different phase shifts. In the present example, the phase shifts are +π/4 and −π/4 radians. Each of the optical paths A and B is terminated by a pair of photodetectors 23-5, 23-6 and 23-7 and 23-8, wherein each pair can be similar to the section 21-5 described in connection with FIG. 21.

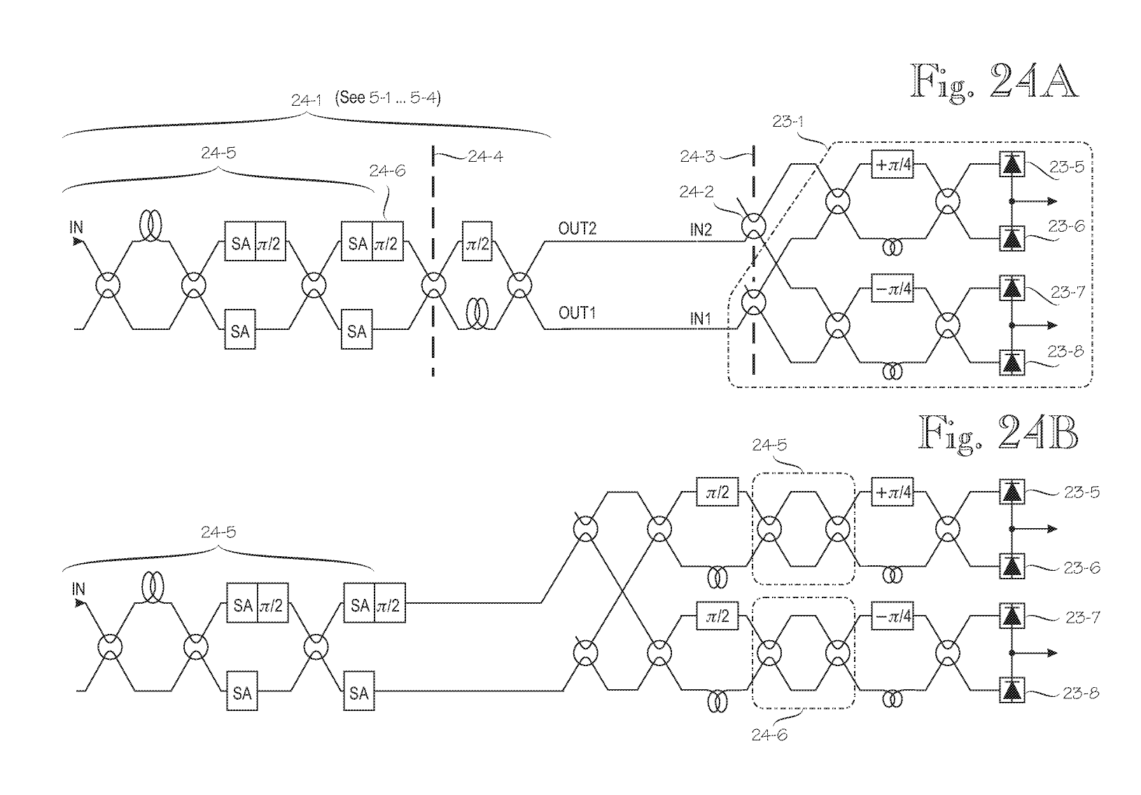

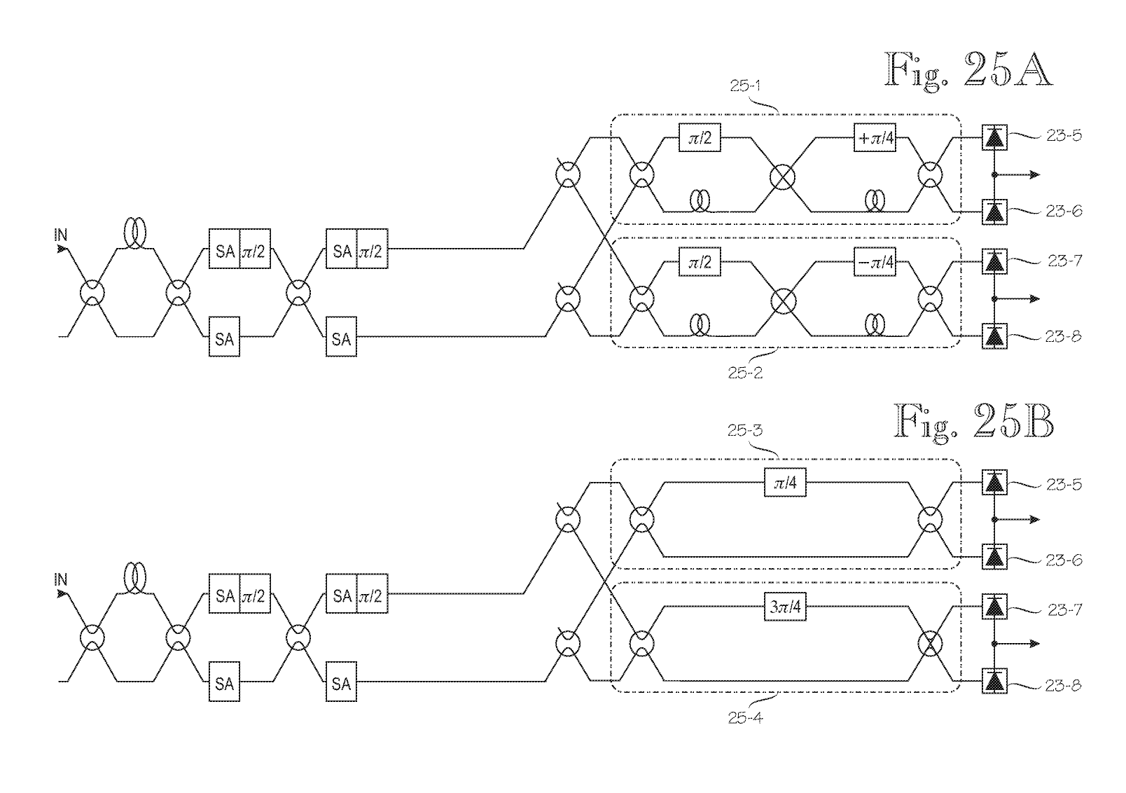

FIGS. 24A, 24B, 25A, 25B, 26A and 26B illustrate how an optical DQPSK regenerator constructed with saturable absorbers can be integrated into an optical DQPSK receiver. Section 24-1 generally denotes an optical regenerator, which can be similar to the one described in connection with FIG. 5. For a detailed description, a reference is made to the description of sections 5-1 through 5-4.

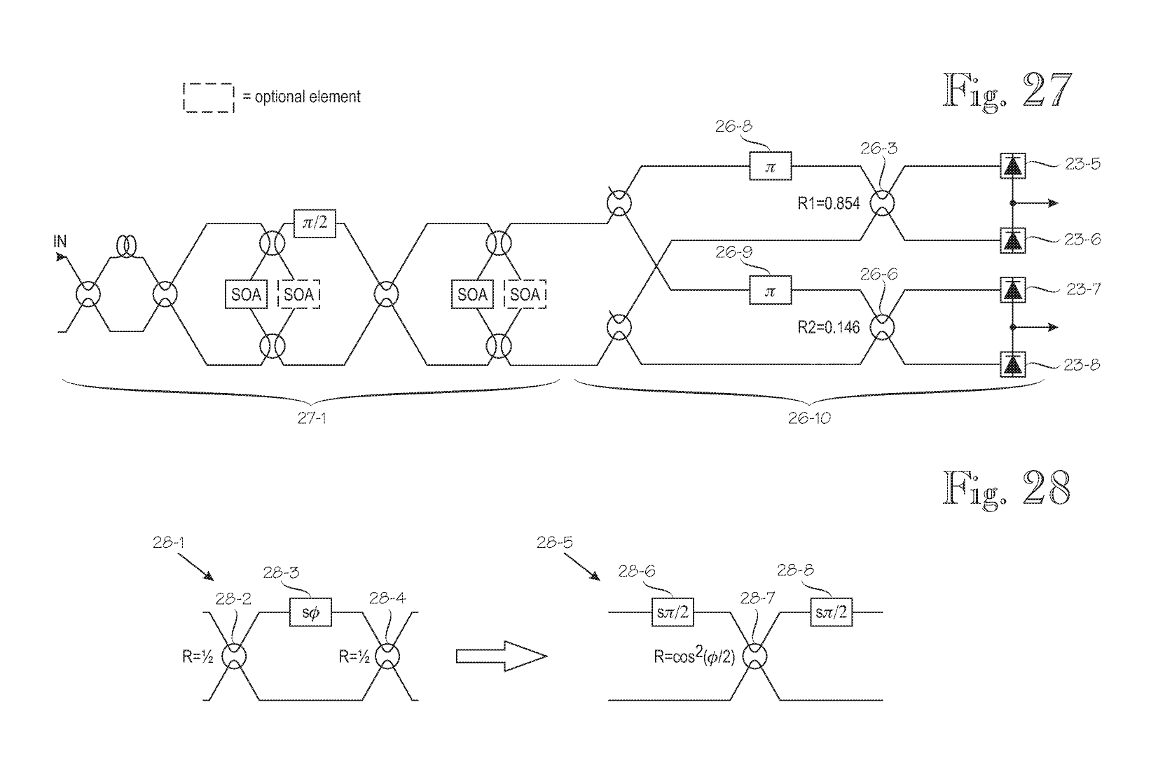

Within the DQPSK regenerator section 24-1, reference numerals 24-5 and 24-6 denote elements whose significance will be described in connection with FIG. 26A.

As described in connection with the DPSK integration example shown in FIGS. 21A-21C and 22, it may be beneficial to connect the two outputs of the optical regenerator to two inputs of the optical receiver. But the DQPSK receiver section 23-1, as described in connection with FIG. 23, only contains one input (labelled “IN” in FIG. 23). In the present embodiment, the DQPSK receiver section 23-1 is complemented with an additional 3 dB coupler 24-2, so as to provide the DQPSK receiver section 23-1 with two inputs, which are labelled IN1 and IN2. The two outputs of the optical regenerator section 24-1, labelled OUT1 and OUT2, are coupled to the respective inputs IN1 and IN2 of the DQPSK receiver section 23-1. Herein, the output OUT2 represents the output which produces substantially only noise, and which is normally left unconnected. As discussed in the DPSK example, system complexity can be reduced by cleverly employing this noisy output.

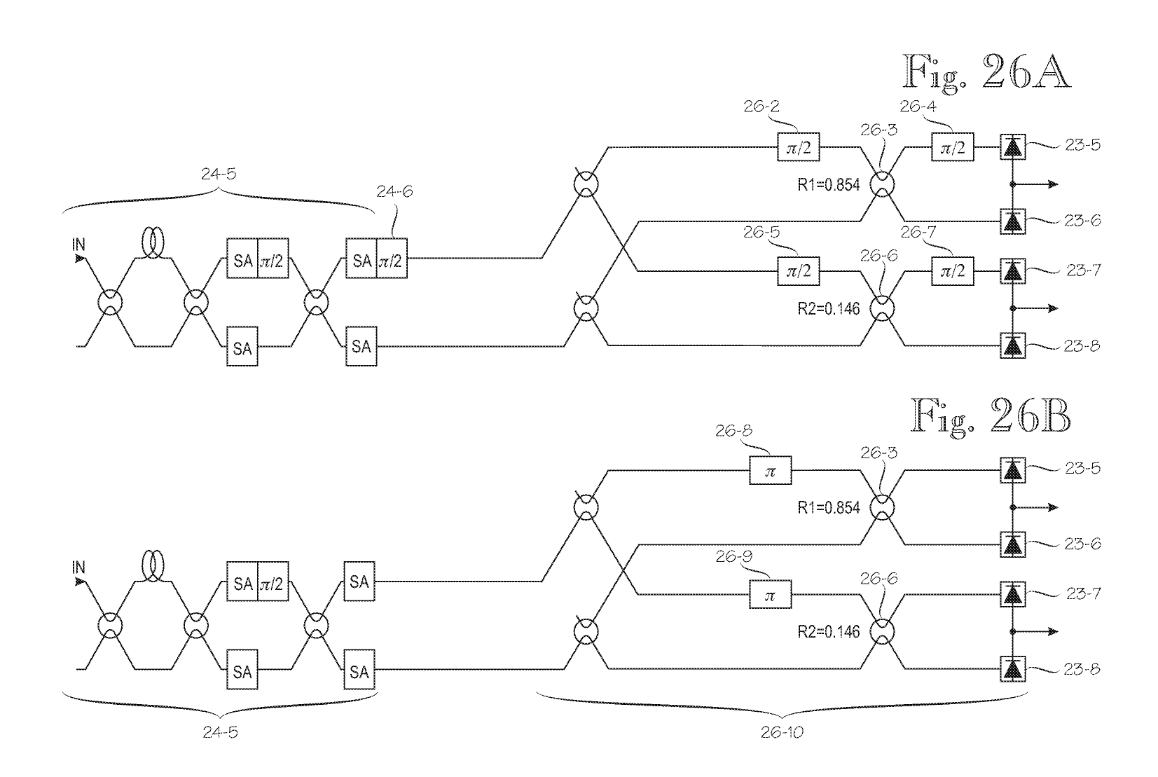

It can be seen that in the embodiment shown in FIG. 24A, everything after (to the right of) a dashed line 24-3 is duplicated (disregarding temporarily a slight asymmetry between the optical paths and the fact that the two interferometers 23-3, 23-4 exhibit mutually different phase shifts). The dashed line 24-3 is thus a duplication point. Now, if the duplication point is moved to the left, to the point indicated by line 24-4, the result is a system as shown in FIG. 24B. This system comprises two Mach-Zehnder interferometers denoted by reference numerals 24-5 and 25-6. These can be replaced by cross-coupling, as shown in FIG. 25A. Within the sections denoted by reference numerals 25-1 and 25-2, delay elements, which are symmetric between the optical paths can be eliminated and phase differences can be summed together. The resulting system is shown in FIG. 25B. This system still comprises two Mach-Zehnder interferometers denoted by reference numerals 25-3 and 25-4. These interferometers exhibit mutually different phase shifts in one of their arms. They can be replaced by their equivalent circuits, such that the first interferometer 25-3 is replaced by two π/2 radian phase shifters 26-2, 26-4 and coupler 26-3, and the second interferometer 25-4 is replaced by two π/2 radian phase shifters 26-5, 26-7 and coupler 26-6, the resulting system is shown in FIG. 26A. It should be noted that the couplers 26-3 and 26-3 are not 3 dB (50:50) couplers. Instead the couplers 26-3 and 26-3 have respective coupling ratios R1=0.854 and R2=0.146. Determination of the proper coupling ratios will be described in connection with FIG. 28.

Because the optical signals are terminated into photodetectors, any phase control after the last two couplers 26-3, 26-6 is insignificant, which is why the two last phase shifters 26-4 and 26-7 can be eliminated. Beginning from FIG. 24A, the section 24-5 and the π/2 radian phase shifter 24-6 have remained unchanged. At this point it can be seen that the π/2 radian phase shifter 24-6 can be moved to the right of the duplication point (item 24-4 in FIG. 24A) and combined with the π/2 radian phase shifters 26-2 and 26-5. FIG. 26B shows the resulting system, in which all phase shifters (apart from the one in the regeneration section 24-5) have been combined into two π radian phase shifters 26-8 and 26-9.

It is worth observing that the straightforward combination of a DQPSK regenerator 24-1, as shown in FIG. 24A, and a DQPKS receiver 23-1, as shown in FIG. 23, comprises a total of ten couplers and five phase shifters. The result of the integration process, as shown in FIG. 26B, comprises seven couplers and three phase shifters. Thus the present integrated system provides significant savings in system complexity, although the savings are far from self-evident, considering the fact that the initial stages of the integrated system, as shown in FIGS. 24A and 24B, are even more complex than the sum of the parts 24-1 and 23-1 (as many as 13 couplers and six phase shifters are shown in FIG. 24B). Those skilled in the art will understand that the drawings described herein are schematic diagrams in the sense that optical path lengths are not necessarily matched although they should be matched in practical working implementations. For instance, all of the four optical paths from the section 24-5 to the couplers 26-3 and 26-6 should be of equal length.

FIG. 27 shows how an optical DQPSK regenerator constructed with semiconductor optical amplifiers having limiting amplification can be integrated into an optical DQPSK receiver. The integrated system shown in FIG. 27 comprises two major sections 27-1 and 26-10. The latter section 26-10 has been extensively described in connection with FIG. 26B, while the former section 27-1 closely resembles the system shown in FIG. 18 (sections 4-1, 18-2, 18-4 and 18-6, minus the second π/2 radian phase shifter 1863, which has been eliminated by combining it with the subsequent phase shifters of the receiver section, according to the teaching of the integration process described in connection with FIGS. 24A through 26B. Again, each pair of SOA components can be replaced by a single SOA component in cases wherein a 6 dB loss in signal amplitude can be tolerated, as stated in connection with FIG. 15. Similarly to the other drawings, FIG. 27 is also drawn as a schematic diagram, and the four optical paths leading to the couplers 26-3 and 26-6 should be of equal length.

FIG. 28 illustrates determination of coupling ratios in a process of combining phase shifters. The left-hand side of FIG. 28 shows a circuit 28-1, which comprises a first 50:50 coupler 28-2, a phase shifter 28-3 and a second 50:50 coupler 28-4. Within FIG. 28, φ stands for a mutual phase shift difference of the two optical paths of the interferometer, caused by a phase shifter, while s stands for the sign of the phase shift. The right-hand side of FIG. 28 shows a circuit 28-5, which is an equivalent circuit of the circuit 28-1. The equivalent circuit 28-5 comprises two sπ/2 radian phase shifters 28-6 and 28-8, which are coupled by a coupler 28-7, the coupling ratio of which is R=cos²(φ/2). The teaching of the replacement process shown in FIG. 28 has been employed in the integration processes described in connection with FIGS. 24A through 26B and 27.

The foregoing description of the present invention and its embodiments relates to modulation formats in which net information (user information) is carried by means of phase modulation only. Those skilled in the art will realize that the description of the invention is also applicable to modulation formats like duobinary and carrier-suppressed return-to-zero format, wherein data is encoded as normalized amplitudes of 0 and 1 and wherein the phase can additionally alternate between 0 and π radians (nominal values).

### Component Construction and Variations of the Described Embodiment

The above description of the various embodiments of the invention is not restricted to any particular implementation of the optical components. Instead the optical components, including but not limited to optical paths, delay elements, phase shifters, couplers, interferometers, saturable absorbers, nonlinear amplifiers, etc., can be constructed by means of any of the available technologies, including optical fibers, wave guides, free-space optical components (such as lenses, mirrors, or gratings), or some other types of optical path construction known to those skilled in the art, or any combinations of such technologies. The optical medium in the optical paths may include glass, such as silica; semiconductor, such as silicon; fluid, such as liquid, gas or gas mixture (eg air), or vacuum.

It is readily apparent to a person skilled in the art that the inventive concept can be implemented in various ways. The invention and its embodiments are not limited to the examples described above but may vary within the scope of the claims. Individual features from various embodiments can be used in combinations which are not described in the present document. For instance, embodiments utilizing non-coupled nonlinear transmission elements may be adapted to utilize coupled nonlinear transmission elements, as described in connection with FIGS. 15-18; the nonlinear transmission elements can exhibit transmission functions that deviate from the precise shapes shown in FIG. 10, as long as the transmission function is generally an increasing function of the input amplitude. While the term “quadrant” has been used in connection with some embodiments, the invention is not restricted to embodiments in which two symbol pairs are evenly distributed among the four quadrants of a circle.

Phase shifting or a phase shifter refers to any means or technique for controlling mutual phase shift between two electromagnetic waves travelling in two respective optical paths. One exemplary technique involves altering the index of refraction of the optical path, by using a temperature difference between the two optical paths. For instance, the optical fiber may be locally heated in one of the optical paths. The heating alters the index of refraction, which in turn alters the optical path length of the electromagnetic wave travelling in the heated optical path. Any phase shift control may take place virtually anywhere along the optical path, or the phase shift control may take place in a distributed manner. Any phase shift of a given sign (plus or minus) in one optical path (A or B) may be replaced by a phase shift of the opposite sign (minus or plus) in the other optical path (B or A). Yet further, the non-linear elements, such as the saturable absorbers (SA) or semiconductor optical amplifiers (SOA) may be used for integrated phase shift control by adjusting their temperature, bias current or the optical power traversing the non-linear element.

The optical couplers used in the various embodiments of the present invention, including the 3 dB couplers and couplers with different coupling ratios, can be constructed by using any of several construction techniques, including but not limited to partially reflecting mirrors, wave guides coupled to one another via an evanescent field, or gratings.

As stated in several contexts above, the drawings are intended to be schematic in the sense that they primarily illustrate the logical arrangement of the novel elements of the invention, such as the coupling of the two regeneration stages via the inter-stage conversion element. Those skilled in the art will understand that practical working implementations based on such schematic drawings may include additional components which are not specifically illustrated or described. An example of such components is the addition of the optical isolators (or circulators) that was described in connection with FIG. 18. Wave plates, half-wave plates or other components which affect polarization, may also be inserted at various points, as needed. Furthermore, the lengths of the various optical paths in the drawings do not necessarily reflect the optical path lengths in practical working implementations.

### REFERENCE DOCUMENTS

1. Pontus Johannison et al.: “Suppression of phase error in differential phase-shift keying data by amplitude regeneration”, Optics Letters; May 15, 2006; Vol. 31, No 10, abbr. “Johannison”.
2. US patent application 2006/0204248 by Vladimir Grigoryan et al., abbr. “Grigoryan”
3. Chia Chien Wei et al.: “Convergence of phase noise in DPSK transmission systems by novel phase noise averagers”, Optics Express; Oct. 16, 2006; Vol. 14, No 21, abbr. “Wei”.

1. An apparatus comprising at least one optical system having the following elements in the following sequence:
a first regeneration stage, a first inter-stage conversion element, and a second regeneration stage; wherein each of said elements has a first optical path and a second optical path, which traverse the element;
wherein the first regeneration stage is configured to receive an optical input signal carrying symbols in a first modulation format which is at least partially phase-modulated such that each symbol has a unique nominal phase value;
wherein the first regeneration stage comprises a first intra-stage conversion element configured to convert the symbols in the first modulation format to symbols in a second modulation format which is a phase/amplitude-modulation format such that each symbol has a unique combination of nominal phase value and nominal amplitude;
wherein each of the first regeneration stage and the second regeneration stage respectively comprises a first amplitude regenerator and a second amplitude regenerator configured to apply amplitude regeneration respectively to a first symbol pair and a second symbol pair, wherein the amplitude regeneration involves reduction of amplitude noise, and the first and second symbol pairs respectively regenerated by the first regeneration stage and the second regeneration stage differ from one another in respect of at least one different feature, which is selected from a group that comprises:
a different nominal phase value assigned to the symbols of the symbol pair, and
a different temporal distance between the symbols of a symbol pair; and
wherein the first inter-stage conversion element is configured to perform a modulation format conversion on an optical signal which is in the phase/amplitude-modulation format and which traverses the first inter-stage conversion element.

2. The apparatus according to claim 1, wherein the second regeneration stage is followed by a second inter-stage conversion element, which is configured to convert a phase/amplitude-modulated signal traversing the second regeneration stage to a phase-modulated signal.

3. The apparatus according to claim 1, wherein:
the first inter-stage conversion element is further configured to transform the optical signal which traverses the first inter-stage conversion element from a first phase/amplitude-modulation format to a second phase/amplitude-modulation format;
wherein the optical signal experiences constructive/destructive interference at a first symbol pair in the first phase/amplitude-modulation format and at a second symbol pair in the second phase/amplitude-modulation format;
wherein the first symbol pair and the second symbol pair exhibit respective phase angles which differ from one another by a predetermined amount.

4. The apparatus according to claim 3, wherein the phase-shifting caused by the first inter-stage conversion element corresponds to the difference between the predetermined phase value pairs at which the two regeneration stages cause the constructive/destructive interference.

5. The apparatus according to claim 1, wherein the first inter-stage conversion element comprises a delay interferometer coupled to the output port of the first inter-stage conversion element.

6. The apparatus according to claim 5, wherein the first optical path and the second optical path of the inter-stage conversion element are coupled to the first optical path and the second optical path of the second regeneration stage, and wherein the second regeneration stage does not have an intra-stage conversion element.

7. The apparatus according to claim 1, wherein at least one of the first regeneration stage and the second regeneration stage comprises an amplitude-dependent amplifier configured to amplify a high-amplitude component of an optical signal more than a low-amplitude component of the optical signal.

8. The apparatus according to claim 1, wherein at least one of the first regeneration stage and the second regeneration stage comprises an amplitude-dependent attenuator configure to attenuate a low-amplitude component of an optical signal more than a high-amplitude component of the optical signal.

9. The apparatus according claim 8, wherein the amplitude-dependent attenuator has a non-linear transmission function defined as a ratio of output amplitude to input amplitude, wherein the non-linear transmission function is a non-decreasing function of the input amplitude.

10. The apparatus according to claim 1, wherein the amplitude regenerator comprises two optical signal paths and the amplitude regenerator is configured to retain a phase relation between optical signals traversing in the two optical signal paths.

11. The apparatus according to claim 1, wherein at least one amplitude regenerator is a coupled amplitude regenerator.

12. The apparatus according to claim 1, wherein at least one amplitude regenerator is a non-coupled amplitude regenerator.

13. The apparatus according to claim 1, wherein the apparatus comprises at least two optical systems, wherein the at least two optical systems are configured to regenerate symbol pairs having a different temporal distance between the symbols of a symbol pair.

14. The apparatus according to claim 1, wherein the apparatus is logically positioned between an optical demultiplexer and an optical receiver.

15. The apparatus according to claim 1, wherein the apparatus is configured to share the first intra-stage conversion element with an optical receiver.

16. A method comprising:
receiving an optical input signal carrying symbols in a first modulation format which is at least partially phase-modulated such that each symbol has a unique nominal phase value;
converting the symbols in the first modulation format to symbols in a second modulation format which is a phase/amplitude-modulation format such that each symbol has a unique combination of nominal phase value and nominal amplitude;
applying a first amplitude regeneration to a first symbol pair, wherein the amplitude regeneration involves reduction of amplitude noise;
performing a modulation format conversion on the optical signal into the second modulation format after the first amplitude regeneration;
applying a second amplitude regeneration to a second symbol pair, wherein the second amplitude regeneration involves reduction of amplitude noise and wherein the first and second symbol pairs differ from one another in respect of at least one different feature, which is selected from a group that comprises a different nominal phase value assigned to the symbols of the symbol pair and a different temporal distance between the symbols of a symbol pair.
